(19) United States
(12) Patent Application Publication
(10) Pub. No.: US 2026/0095950 A1
(43) Pub. Date: Apr. 2, 2026

(54) RANDOM ACCESS MESSAGE TRANSMISSION SCHEMES WITH CYCLIC SHIFT

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Junyi LI, Greentown, PA (US); Yan ZHOU, San Diego, CA (US); Ori SHENTAL, Marlboro, NJ (US); Jing JIANG, San Diego, CA (US)

(21) Appl. No.: 18/905,074

(22) Filed: Oct. 2, 2024

(51) Int. Cl. H04W 74/0833; H04W 76/10

(52) U.S. Cl. CPC H04W 74/0833; H04W 76/10

(57) ABSTRACT

Methods, systems, and devices for wireless communications are described. A user equipment (UE) may transmit a random access preamble via a random access occasion (RO) in accordance with a cyclic shift (CS) and a CS offset. The UE may receive, from a network entity, a first response message that indicates information associated with one or more random access paths detected by a network entity within a threshold duration. The UE may determine whether one or more collisions occur based on the information and may refrain from transmitting a random access message when two or more estimated random access paths are detected within a threshold duration of its CS and CS offset. The UE may receive a second response message based on refraining from transmitting the random access message. The UE may establish a connection with the network entity based on receiving the second response message.

### FIELD OF TECHNOLOGY

The following relates to wireless communications, including random access message transmission schemes with cyclic shift.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a random access preamble via a random access occasion in accordance with a cyclic shift of a set of candidate cyclic shifts and with a cyclic shift offset of a set of candidate cyclic shift offsets, receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure, refraining from transmitting the random access message when two or more estimated random access paths indicated by the first response message are detected within a threshold duration of the cyclic shift and the cyclic shift offset, and receiving, based on refraining from transmitting the random access message, a second response message including second information indicating a second set of resources for transmitting a second random access preamble associated with a second random access procedure.

A UE for wireless communications is described. The UE may include one or more memories storing processor executable code, and one or more processors coupled with the one or more memories. The one or more processors may individually or collectively be operable to execute the code to cause the UE to transmit a random access preamble via a random access occasion in accordance with a cyclic shift of a set of candidate cyclic shifts and with a cyclic shift offset of a set of candidate cyclic shift offsets, receive, based on transmitting the random access preamble, a first response message indicating information associated with one or more estimated random access paths corresponding to one or more random access preambles received by a network entity within a duration, the information including an indication of a set of resources for transmitting a random access message of a random access procedure, refrain from transmitting the random access message when two or more estimated random access paths indicated by the first response message are detected within a threshold duration of the cyclic shift and the cyclic shift offset, and receive, based on refraining from transmitting the random access message, a second response message including second information indicating a second set of resources for transmitting a second random access preamble associated with a second random access procedure.

Another UE for wireless communications is described. The UE may include means for transmitting a random access preamble via a random access occasion in accordance with a cyclic shift of a set of candidate cyclic shifts and with a cyclic shift offset of a set of candidate cyclic shift offsets, means for receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure, means for refraining from transmitting the random access message when two or more estimated random access paths indicated by the first response message are detected within a threshold duration of the cyclic shift and the cyclic shift offset, and means for receiving, based on refraining from transmitting the random access message, a second response message including second information indicating a second set of resources for transmitting a second random access preamble associated with a second random access procedure.

A non-transitory computer-readable medium storing code for wireless communications is described. The code may include instructions executable by one or more processors to transmit a random access preamble via a random access occasion in accordance with a cyclic shift of a set of candidate cyclic shifts and with a cyclic shift offset of a set of candidate cyclic shift offsets, receive, based on transmitting the random access preamble, a first response message indicating information associated with one or more estimated random access paths corresponding to one or more random access preambles received by a network entity within a duration, the information including an indication of a set of resources for transmitting a random access message of a random access procedure, refrain from transmitting the random access message when two or more estimated random access paths indicated by the first response message are detected within a threshold duration of the cyclic shift and the cyclic shift offset, and receive, based on refraining from transmitting the random access message, a second response message including second information indicating a second set of resources for transmitting a second random access preamble associated with a second random access procedure.

Some examples of the method, UEs, and non-transitory computer-readable medium described herein may further include operations, features, means, or instructions for selecting the cyclic shift offset from the set of candidate cyclic shift offsets based on a pseudo-random function.

Some examples of the method, UEs, and non-transitory computer-readable medium described herein may further include operations, features, means, or instructions for receiving, prior to transmitting the random access preamble, an indication of the set of candidate cyclic shift offsets and selecting the cyclic shift offset from the set of candidate cyclic shift offsets based on receiving the indication, where transmitting the random access preamble may be based on selecting the cyclic shift offset.

Some examples of the method, UEs, and non-transitory computer-readable medium described herein may further include operations, features, means, or instructions for transmitting the random access message when a single estimated random access path indicated by the first response message may be detected within the threshold duration of the cyclic shift and the cyclic shift offset, receiving a third response message based on transmitting the random access message, and establishing a connection with a serving cell of the network entity based on receiving the third response message.

Some examples of the method, UEs, and non-transitory computer-readable medium described herein may further include operations, features, means, or instructions for transmitting the second random access preamble in accordance with a second random access occasion indicated by the second set of resources based on receiving the second response message.

Some examples of the method, UEs, and non-transitory computer-readable medium described herein may further include operations, features, means, or instructions for receiving a third response message based on transmitting the second random access preamble, transmitting a second random access message based on receiving the third response message, and establishing a connection with a serving cell of the network entity based on transmitting the second random access message.

Some examples of the method, UEs, and non-transitory computer-readable medium described herein may further include operations, features, means, or instructions for receiving, via the first response message, an indication of one or more detected cyclic shifts that may be detected by the network entity within the duration, each of the one or more detected cyclic shifts corresponding to a respective estimated random access path of the one or more estimated random access paths.

Some examples of the method, UEs, and non-transitory computer-readable medium described herein may further include operations, features, means, or instructions for calculating, when a single estimated random access path may be detected within the threshold duration of the cyclic shift and the cyclic shift offset, a timing advance based on a difference between a detected cyclic shift and the cyclic shift and the cyclic shift offset used for transmitting the random access preamble and transmitting the random access message based on calculating the timing advance.

In some examples of the method, UEs, and non-transitory computer-readable medium described herein, the information further includes a transmit power control command for each random access path of the one or more estimated random access paths and a random access message may be transmitted in accordance with the transmit power control command.

Some examples of the method, UEs, and non-transitory computer-readable medium described herein may further include operations, features, means, or instructions for comparing each of the one or more estimated random access paths to the threshold duration and detecting a quantity of the one or more estimated random access paths within the threshold duration of the cyclic shift and the cyclic shift offset based on the comparing.

In some examples of the method, UEs, and non-transitory computer-readable medium described herein, the threshold duration may be associated with a round trip time (RTT) between a serving cell and the UE.

A method for wireless communications by a network entity is described. The method may include detecting a first random access path and a second random access path based on one or more transmissions of a first random access preamble obtained during a first random access occasion, outputting, based on detecting the first random access path and the second random access path, a first response message including information associated with one or more estimated random access paths including at least the first random access path and the second random access path, the information including an indication of a first set of resources for transmitting a random access message of a first random access procedure, obtaining a first random access message associated with the first random access path based on outputting the first response message, and outputting a second response message associated with the second random access path based on failing to receive a second random access message associated with the second random access path, the second response message including second information associated with a second set of resources for transmitting a second random access preamble associated with a second random access procedure.

A network entity for wireless communications is described. The network entity may include one or more memories storing processor executable code, and one or more processors coupled with the one or more memories. The one or more processors may individually or collectively be operable to execute the code to cause the network entity to detect a first random access path and a second random access path based on one or more transmissions of a first random access preamble obtained during a first random access occasion, output, based on detecting the first random access path and the second random access path, a first response message including information associated with one or more estimated random access paths including at least the first random access path and the second random access path, the information including an indication of a first set of resources for transmitting a random access message of a first random access procedure, obtain a first random access message associated with the first random access path based on outputting the first response message, and output a second response message associated with the second random access path based on failing to receive a second random access message associated with the second random access path, the second response message including second information associated with a second set of resources for transmitting a second random access preamble associated with a second random access procedure.

Another network entity for wireless communications is described. The network entity may include means for detecting a first random access path and a second random access path based on one or more transmissions of a first random access preamble obtained during a first random access occasion, means for outputting, based on detecting the first random access path and the second random access path, a first response message including information associated with one or more estimated random access paths including at least the first random access path and the second random access path, the information including an indication of a first set of resources for transmitting a random access message of a first random access procedure, means for obtaining a first random access message associated with the first random access path based on outputting the first response message, and means for outputting a second response message associated with the second random access path based on failing to receive a second random access message associated with the second random access path, the second response message including second information associated with a second set of resources for transmitting a second random access preamble associated with a second random access procedure.

A non-transitory computer-readable medium storing code for wireless communications is described. The code may include instructions executable by one or more processors to detect a first random access path and a second random access path based on one or more transmissions of a first random access preamble obtained during a first random access occasion, output, based on detecting the first random access path and the second random access path, a first response message including information associated with one or more estimated random access paths including at least the first random access path and the second random access path, the information including an indication of a first set of resources for transmitting a random access message of a first random access procedure, obtain a first random access message associated with the first random access path based on outputting the first response message, and output a second response message associated with the second random access path based on failing to receive a second random access message associated with the second random access path, the second response message including second information associated with a second set of resources for transmitting a second random access preamble associated with a second random access procedure.

Some examples of the method, network entities, and non-transitory computer-readable medium described herein may further include operations, features, means, or instructions for allocating, prior to outputting the first response message, the first set of resources for transmitting the random access message, the first set of resources including one or more second random access occasions associated with the first random access procedure.

Some examples of the method, network entities, and non-transitory computer-readable medium described herein may further include operations, features, means, or instructions for detecting a third random access path based on the one or more transmissions of the first random access preamble obtained during the first random access occasion and obtaining a third random access message associated with the third random access path based on outputting the first response message, the third random access message corresponds to a third UE.

Some examples of the method, network entities, and non-transitory computer-readable medium described herein may further include operations, features, means, or instructions for determining that a collision occurred between the first random access path and the second random access path based on failing to receive the second random access message, where outputting the second response message may be based on determining that the collision occurred.

Some examples of the method, network entities, and non-transitory computer-readable medium described herein may further include operations, features, means, or instructions for outputting, prior to detecting the first random access path and the second random access path, an indication of a set of candidate cyclic shift offsets, where obtaining the one or more transmissions of the first random access preamble may be based on outputting the indication of the set of candidate cyclic shift offsets.

Some examples of the method, network entities, and non-transitory computer-readable medium described herein may further include operations, features, means, or instructions for outputting a third response message based on obtaining the first random access message and establishing a connection with a first UE associated with the first random access path based on outputting the third response message.

Some examples of the method, network entities, and non-transitory computer-readable medium described herein may further include operations, features, means, or instructions for obtaining the second random access preamble in accordance with the second set of resources based on outputting the second response message and outputting a third response message based on obtaining the second random access preamble.

Some examples of the method, network entities, and non-transitory computer-readable medium described herein may further include operations, features, means, or instructions for obtaining a third random access message based on outputting the third response message and establishing a connection with a second UE associated with the second random access path based on obtaining the third random access message.

Some examples of the method, network entities, and non-transitory computer-readable medium described herein may further include operations, features, means, or instructions for outputting, via the first response message, an indication of one or more detected cyclic shifts that may be detected by the network entity within the first random access occasion, each of the one or more detected cyclic shifts corresponding to a respective estimated random access path of the one or more estimated random access paths.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access message transmission schemes with cyclic shift in accordance with one or more aspects of the present disclosure.

FIG. 2 shows an example of a wireless communications system that supports random access message transmission schemes with cyclic shift in accordance with one or more aspects of the present disclosure.

FIG. 3 shows an example of a timeline that supports random access message transmission schemes with cyclic shift in accordance with one or more aspects of the present disclosure.

FIG. 4 shows an example of a timeline that supports random access message transmission schemes with cyclic shift in accordance with one or more aspects of the present disclosure.

FIG. 5 shows an example of a random access scheme that supports random access message transmission schemes with cyclic shift in accordance with one or more aspects of the present disclosure.

FIG. 6 shows an example of a process flow that supports random access message transmission schemes with cyclic shift in accordance with one or more aspects of the present disclosure.

FIGS. 7 and 8 show block diagrams of devices that support random access message transmission schemes with cyclic shift in accordance with one or more aspects of the present disclosure.

FIG. 9 shows a block diagram of a communications manager that supports random access message transmission schemes with cyclic shift in accordance with one or more aspects of the present disclosure.

FIG. 10 shows a diagram of a system including a device that supports random access message transmission schemes with cyclic shift in accordance with one or more aspects of the present disclosure.

FIGS. 11 and 12 show block diagrams of devices that support random access message transmission schemes with cyclic shift in accordance with one or more aspects of the present disclosure.

FIG. 13 shows a block diagram of a communications manager that supports random access message transmission schemes with cyclic shift in accordance with one or more aspects of the present disclosure.

FIG. 14 shows a diagram of a system including a device that supports random access message transmission schemes with cyclic shift in accordance with one or more aspects of the present disclosure.

FIGS. 15 through 19 show flowcharts illustrating methods that support random access message transmission schemes with cyclic shift in accordance with one or more aspects of the present disclosure.

### DETAILED DESCRIPTION

Some wireless communications systems may support random access procedures (e.g., random access channel (RACH) procedures). Various user equipments (UEs) may transmit a first random access message (e.g., including a preamble, a first message (Msg 1) of a four-step random access procedure). In some cases, each UE may select a cyclic shift (CS) and a root for the preamble, and may transmit the preamble via a corresponding random access occasion (RO). However, some UEs may attempt to access a cell of a network entity using a same set of resources (e.g., using a same preamble, a same root, or a same CS) as part of the random access procedure. If multiple UEs successfully access the cell using the same resources, their respective communications may collide, resulting in reduced communication quality between the UEs and the cell.

In some cases, a UE may perform pseudo-random function to select a CS. For instance, the UE may perform a dithering operation (e.g., CS dithering) in which the UE may apply a randomized offset (e.g., a CS offset) to the selected CS to mitigate collisions. However, in some cases, an applied CS may not be sufficient to avoid collisions. Moreover, the network entity may not accurately estimate the collisions. For instance, a network entity may detect multiple access paths (e.g., multiple transmissions of Msg 1 in a RACH procedure) that are within a threshold duration (e.g., a round trip time (RTT) duration) of each other, and the network entity may not be able to accurately estimate whether a collision occurs at the UEs associated with the multiple detected paths. As such, a wireless communications system may experience increased system delays, inefficient use of available system resources, decreased throughput, increased system latency, and decreased user experience.

In accordance with one or more techniques herein, a UE may support collision detection of random access messages (e.g., collision of random access paths) between itself and one or more other UEs. For example, each UE may transmit a preamble (e.g., via Msg 1) to the network entity via respective random access paths (e.g., a path corresponding to a selected cyclic shift and a cyclic shift offset). The network entity may transmit a first response message (e.g., a second message (Msg 2) of a four-step random access procedure) for each of the detected paths. Each first response message may include allocated resources for a corresponding UE to transmit a subsequent random access message (e.g., a third message (Msg 3) in a four-step random access procedure). In some examples, each first response message may additionally indicate a list of one or more random access paths detected by the network entity. Based on the indicated paths, each UE may determine whether its own path is located (e.g., in a CS domain) within a threshold duration (e.g., an RTT duration associated with the cell being accessed).

If a UE detects two or more paths within the threshold duration (e.g., the UE's own path and at least one other path), the UE may refrain from transmitting a random access message (e.g., Msg 3), which may indicate to the network entity that a collision occurred. Subsequently, the network entity may transmit a second response message (e.g., a message x (Msg X)) that allocates a second set of resources for the UE to transmit a random access message (e.g., a message y (Msg Y)). Alternatively, if a UE detects a single path (e.g., the UE's own path, or if the UE does not detect more than one path) within the threshold duration, the UE may proceed with transmitting the subsequent random access message (e.g., Msg 3) in accordance with the resources allocated in the first response message (e.g., Msg 2), which may indicate to the network entity that no collisions occurred. Thus, the network entity may determine whether collisions occur between random access paths based on successfully or unsuccessfully receiving random access messages via each path, which may reduce system latency, support more-efficient use of system resources, increase throughput, and improve user experience in the wireless communications system.

Aspects of the disclosure are initially described in the context of wireless communications systems. Aspects of the disclosure are further illustrated by and described with reference to timelines, random access schemes, process flows, apparatus diagrams, system diagrams, and flowcharts that relate to random access message transmission schemes with cyclic shift.

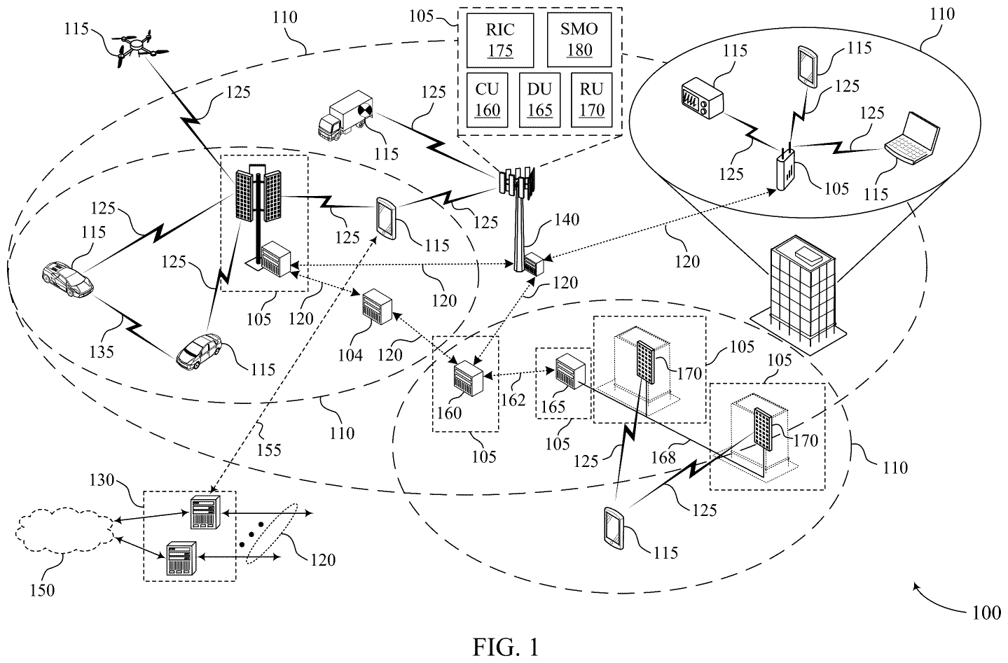

FIG. 1 shows an example of a wireless communications system 100 that supports random access message transmission schemes with cyclic shift in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support random access message transmission schemes with cyclic shift as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems 100 may support random access procedures (e.g., RACH procedures) in which UEs 115 may transmit a first random access message (e.g., including a preamble, Msg 1). In some cases, each UE 115 may select a CS and a root for the preamble, and may transmit the preamble via a corresponding RO. However, some UEs 115 may attempt to access a cell of a network entity 105 using a same preamble (e.g., associated with a same root, or a same CS) as part of the random access procedure. In some cases, the network entity 105 may not accurately estimate collisions between the UEs that use the same preamble. As such, the wireless communications system 100 may experience increased system delays, inefficient use of available system resources, decreased throughput, increased system latency, and decreased user experience.

In accordance with one or more techniques herein, a UE 115 may support collision detection of random access messages (e.g., collision of random access paths) between itself and one or more other UEs 115. For example, each UE 115 may transmit a preamble (e.g., via Msg 1) to the network entity 105 via respective random access paths. The network entity 105 may transmit a first response message (e.g., Msg 2) for each of the detected paths. In some examples, the first response message may additionally indicate a list of one or more random access paths detected by the network entity 105. Based on the indicated paths, each UE 115 may determine whether its own path is located (e.g., in a CS domain) within a threshold duration (e.g., a max RTT associated with the cell being accessed).

If a UE 115 detects two or more paths within the threshold duration, the UE 115 may refrain from transmitting a random access message (e.g., Msg 3). Subsequently, the network entity 105 may transmit a second response message (e.g., a message x (Msg X)) that allocates a second set of resources for the UE 115 to transmit a random access message (e.g., a message y (Msg Y)). Alternatively, if a UE 115 detects a single path (e.g., or if the UE does not detect more than one path) within the threshold duration, the UE 115 may proceed with transmitting the subsequent random access message (e.g., Msg 3). By applying such techniques, the wireless communications system 100 may support reduced system latency, more-efficient use of system resources, increased throughput, and improved user experience.

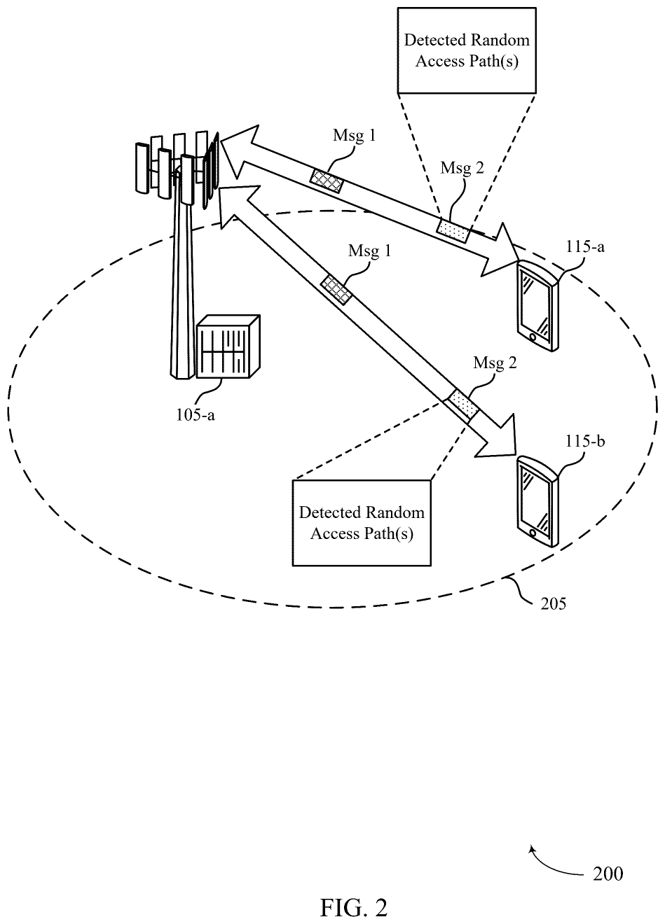

FIG. 2 shows an example of a wireless communications system 200 that supports random access message transmission schemes with CS in accordance with one or more aspects of the present disclosure. The wireless communications system 200 may implement, or be implemented by, aspects of the wireless communications system 100. For example, the wireless communications system 100 may include one or more network entities 105 (e.g., the network entity 105-a) and one or more UEs 115 (e.g., the UE 115-a and the UE 115-b), which may be examples of corresponding devices described with reference to FIG. 1. The network entity 105-a may perform wireless communications with the UE 115-a and the UE 115-b, which may be located within a coverage area 205.

In some cases, one or more UEs 115 may perform random access procedures (e.g., a RACH procedure via a physical random access channel (PRACH). For instance, each UE 115 that is performing a RACH procedure may randomly select a preamble (e.g., a CS and a root), and may transmit a first message in the RACH procedure. Techniques described herein may apply to any random access procedure. For example, some techniques described herein may be described in the context of a four-step random access procedure. However, such techniques may also be applied to any random access procedure (e.g., a two-step random access procedure). In some cases, the UE 115-a may select a preamble and a CS, and may transmit a first message (e.g., Msg 1) of a four-step RACH procedure, and the UE 115-b may also select a preamble and a CS, and may transmit a first message (e.g., Msg 1) of a four-step RACH procedure.

The network entity 105-a may detect a random access path from each of multiple UEs 115. Detection of a random access path may correspond to detection of (e.g., reception of or processing of) a channel. For instance, the UE 115-a may select a preamble corresponding to an RO. Each RO may correspond to multiple candidate preambles. The UE 115-a may select a CS and preamble, and may transmit a Msg 1 via corresponding RO via a PRACH. The network entity may monitor for the transmitted preambles (e.g., Msg 1) after each RO. The network entity 105-a may monitor for random access signaling and may detect one or more transmissions (e.g., a first Msg 1 transmitted by the UE 115-a). The network entity 105-a may process the Msg 1 and determine the channel based thereon. The detection of the Msg 1 (e.g., the channel detected based on monitoring for and processing the Msg 1) may be referred to as a random access path or a RACH path. For instance, if the network entity 105-a detects (e.g., decodes) the Msg 1 received from the UE 115-a after a given RO (e.g., and prior to a next RO, where a time offset between the first RO and the next RO is based on or equal to a cell size corresponding to the coverage area 205), the network entity 105-a may detect a first random access path (e.g., corresponding to a Msg 1 transmitted by the UE 115-a).

The network entity 105-a may detect random access paths from multiple UEs 115. For instance, the network entity 105-a may detect a random access path from the UE 115-a (e.g., a Msg 1 transmitted by the UE 115-a) and may detect a random access path from the UE 115-b (e.g., a Msg 1 transmitted by the UE 115-b). The network entity 105-a may transmit a response message (e.g., Msg 2) for each of the detected preambles (e.g., a Msg 2 for the UE 115-a and a Msg 2 for the UE 115-b), where each Msg 2 allocates resources for a Msg 3 transmission by the respective UEs 115. After receiving a Msg 2, each UE 115 may transmit a random access message (e.g., Msg 3), and may monitor for a contention resolution message (e.g., Msg 4). Similar techniques may be performed in a two-step RACH procedure (e.g., the UE 115-a and the UE 115-b may transmit a Msg A, and monitor for a Msg B).

If multiple UEs 115 (e.g., the UE 115-a and the UE 115-b) select the same preamble (e.g., and transmit Msg 1 via the same RO), then a collision may occur for Msg 3 transmission. For example, the UE 115-a and the UE 115-b may both transmit Msg 1 via the same RO, and receive a Msg 2 (e.g., both corresponding to the same selected preamble) granting Msg 3 resources from the network entity 105-a. As the Msg 3 resources are the same for both the UE 115-a and the UE 115-b, both the UE 115-a and the UE 115-b may transmit a Msg 3 using the same resources, resulting in failed transmission by one (e.g., or both) UEs 115. For instance, the UE 115-b may transmit a Msg 3 via the same resources as the UE 115-a. The network entity 105-a may not receive the Msg 3 transmitted by the UE 115-b, and may therefore not transmit a contention resolution message. The UE 115-b may monitor for a final random access message (e.g., a two or four step RACH procedure), and upon expiration of a timer (e.g., a contention resolution timer), or upon reception of a Msg 4 with a mismatched UE identifier (e.g., a Msg 4 transmitted to the UE 115-a and detected by the UE 115-b), the UE 115-b may reinitiate the RACH procedure (e.g., transmitting another Msg 1 via another preamble and another RO). Such collisions of random access messages (e.g., Msg 3) may result in increased delays for one or more UEs 115 (e.g., the UE 115-b), increased system congestion and system latency, inefficient use of resources, etc.).

In some examples, the network entity 105-a may detect a scenario in which msg 1 transmissions are received from multiple UEs 115 (e.g., msg 1 is transmitted using the same preamble and RO by both the UE 115-a and the UE 115-b). In such examples, the network entity 105-a may signal for the UEs 115 to send additional msg 1 with a new random hashing in a dedicated resource (e.g., RO), such that the retransmissions of msg 1 do not collide (e.g., do not have the same root or CS) anymore, resulting in separable msg 1 transmissions, and differentiation of UEs 115 by the network entity 105-a.

In some examples, the network entity 105-a may perform collision detection using multipath detection (e.g., in the time domain). For example, in some cases (e.g., in case of a large cell), different UEs 115 located in different locations (e.g., near and far) might select a same root and CS for a PRACH transmission. Such transmissions may arrive at the network entity 105-a at different times, in which case the network entity 105-a may detect different UEs 115 based on the arrival time (e.g., difference in time of the same preamble arriving at the network entity 105-a). The network entity 105-a may assume a detected multipath for the same CSs coming from different users, and may perform a collision resolution. However, collision resolution dependent upon multipath detection may result in false positives in the case where a UE 115 transmits the preamble via multipath signaling (e.g., a MIMO deployment), resulting in additional delays and increased signaling overhead. Further, in some examples, (e.g., in the case of a small cell where round trip time (RTT) is similar for multiple UEs 115, or other cases in which the UE 115-a and the UE 115-b are located physically close to each other), an arrival time of RACH signaling (e.g., msg 1) by multiple UEs 115 may be the same, or may be close enough as to make distinguishing the multiple UEs 115 based on timing difficult or impossible for the network entity 105-a. In such examples, if the UE 115-a and the UE 115-b both transmit the same preamble via the same RO (e.g., and are located close to each other), then the network entity 105-a may not successfully detect the multiple UEs 115 based on timing (e.g., the network entity 105-a may detect only a single random access path for both the UE 115-a and the UE 115-b, and may send a single msg 2). Such scenarios may occur in small cells, or large cells with hot spots with multiple users present in a small area.

In some examples, to improve multipath detection by the network entity 105-a, UEs 115 may apply a pseudo-random function (e.g., dithering, UE dithering, CS dithering) for PRACH transmissions. For example, the UE 115-a and the UE 115-b may select the same preamble for a Msg 1 transmission. However, each may apply (e.g., randomly, in accordance with the pseudo-random function) UE dithering to the CS (e.g., such that a transmission time based on a nominal CS is changed according to the dithering). The network entity 105-a may not have access to information regarding what (e.g., or how much) dithering is chosen (e.g., applied) to a Msg 1 transmission by each UE 115. However, the network entity 105-a may identify a detected CS, which is the result of a UE selected CS plus the CS dithering plus a propagation delay translated CS. UE dithering may be performed using a selected frequency shift on the transmitted preamble sequence. Thus, UEs 115 may select the same preamble and may correspond to the same RTT (e.g., the UE 115-a and the UE 115-b may be closely located within the coverage area 205). Both the UE 115-a and the UE 115-b may perform the CS dithering, and the network entity 105-a may detect multiple random access paths, and perform collision resolution (e.g., may avoid collisions of Msg 3 based on inadvertently granting the same Msg 3 resources to multiple UEs 115).

Although example implementations described herein refer to one or more dithering operations, one or more other techniques may be utilized to apply a CS offset, in addition, or in alternate to dithering operations. For example, a network entity 105-a may provide (e.g., indicate, transmit, output, based on an overprovisioning operation) a set of multiple CS (e.g., an CS offsets, candidate CS offsets) for each preamble. Based on the provision of the multiple CSs, each UE may be configured to select a preamble and additionally select a CS (e.g., and a CS offset) to use for the preamble. Accordingly, such techniques may be utilized in addition, or in alternate to one or more dithering operations described herein (e.g., including with reference to FIG. 2-6).

In some examples, some UEs may be erroneously categorized as experiencing a collision, resulting in increased delays and system latency. Thus, according to techniques described herein, the UEs 115 may support detection of random access path collisions. For example, the network entity 105-a may transmit a random access response message (e.g., Msg 2) to each of the UEs 115 (e.g., both the UE 115-a and the UE 115-b). The response messages may include a list (e.g., including one or more) of each random access path detected by the network entity 105-a. The UEs 115 may use the list (e.g., indicated by the network entity 105-a) to determine a quantity of paths that are within a threshold duration of its own selected CS (e.g., plus any dithering).

If no collision is detected, a UE 115 may proceed with transmission of a random access message (e.g., Msg 3). If a collision is detected, the UE 115 may refrain from transmitting the random access message, which may indicate to the network entity 105-a that a collision occurred. Based on a failure to receive the random access message (e.g., the Msg 3), the network entity 105-b may transmit another response message (e.g., a Msg X) to allocate another set (e.g., a different set) of resources for the UE to transmit a random access message (e.g., a Msg Y). Such techniques may improve accuracy of collision detection, decreased system latency, improve efficient use of resources, and improve user experience in the wireless communications system 200.

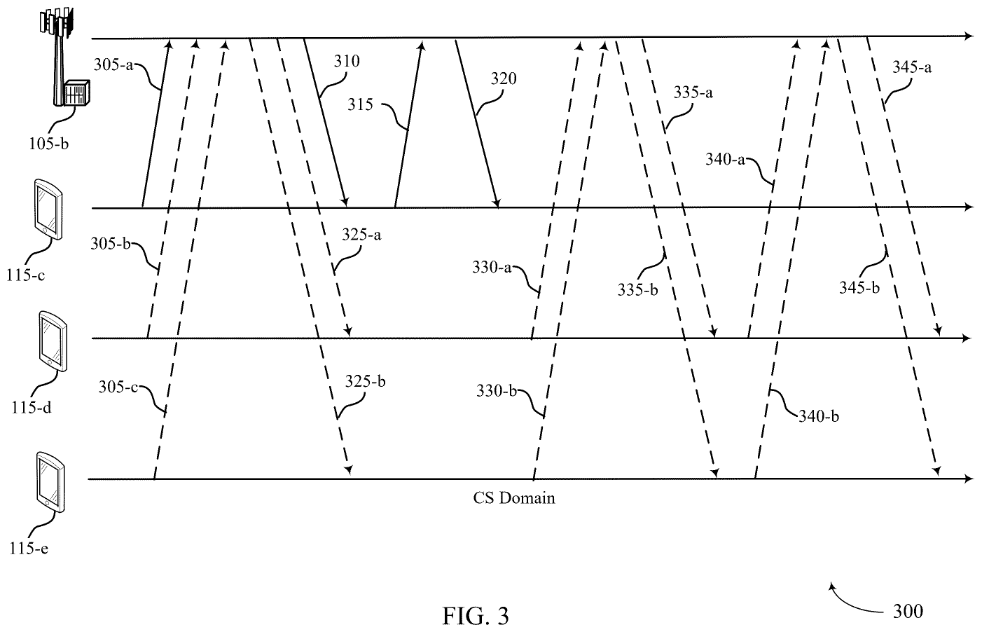

FIG. 3 shows an example of a timeline 300 that supports random access message transmission schemes with CS in accordance with one or more aspects of the present disclosure. The timeline 300 may implement, or be implemented by, aspects of the wireless communications system 100, and the wireless communications system 200. For example, one or more network entities 105 (e.g., the network entity 105-b) and one or more UEs 115 (e.g., the UE 115-c, the UE 115-d, and the UE 115-e), which may be examples of corresponding devices described with reference to FIG. 1-2, may communicate in accordance with the timeline 300. Although illustrated with reference to a four-step random access procedure, techniques described herein may be similarly applied to any random access procedure (e.g., a two-step random access procedure).

In some examples, the network entity 105-b may perform collision detection (e.g., based on dithering performed by one or more UEs 115). For example, the UE 115-c, the UE 115-d, and the UE 115-e may all transmit a random access message 305 (e.g., Msg 1) via a same RO. Two or more of the UEs 115 may select a same preamble, but may apply CS dithering to the selected CS. The network entity 105-b may detect multipath scenarios based on the difference between multiple paths, and may trigger either a random access response 310 (e.g., Msg 2 granting Msg 3 resources, a random access message), or a random access response 325 (e.g., a random access message. The network entity 105-b may detect multiple random access paths (e.g., a preamble with preamble collision), but may not assign an accurate timing to the detected users. The network entity 105-b may thus transmit a random access response 325 to colliding users, and a random access response 310 to non-colliding users. Preamble collision detection by the network entity 105-b may be based on various implementations, and may depend on a CS difference between detected paths.

For example, the UE 115-c may transmit the random access message 305-a (e.g., Msg 1), the UE 115-c may transmit the random access message 305-b (e.g., Msg 1), and the UE 115-e may transmit the random access message 305-c (e.g., Msg 1). In some examples, the random access message 305-b and the random access message 305-c may correspond to the same preamble (e.g., and the random access message 305-a may correspond to a different preamble). In some examples, the random access message 305-a may also correspond to the same preamble, but a CS dither applied by the UE 115-c may result in effective distinguishing between the random access message 305-a and other detected random access paths by the network entity 105-b. The network entity 105-b may detect a random access path corresponding to the UE 115-c, and may detect one or more additional random access paths corresponding to the UE 115-d and the UE 115-e (e.g., the network entity 105-b may detect a collision between Msg 1 transmissions by the UE 115-d and the UE 115-e). The network entity 105-b may transmit the random access response 310 (e.g., Msg 2, a random access message) to the UE 115-c, and the random access response 310 may grant resources for the random access message 315 (e.g., Msg 3). The UE 115-c may transmit the random access message 315, and receive a contention resolution message 320.

The network entity 105-b may transmit a random access response 325 to colliding users. For example, the network entity 105-b may determine (e.g., based on the detected random access paths corresponding to the UE 115-d and the UE 115-e) a potential collision between the UE 115-d and the UE 115-e. A random access response 325 may be referred to, for example, as Msg X, or message X, or Msg 2, among other examples. For example, the random access response 325 may be similar to or the same as a Msg 2 in a four-step random access procedure, and may allocate resources for another random access message (e.g., a random access message 330, which may be referred to as Msg Y, message Y, or Msg 3, among other examples). For instance, a random access response 310 (e.g., Msg 2) may grant resources for a continuation of an initiated random access procedure (e.g., Msg 2 grants resources for Msg 3). A random access response 325 (e.g., Msg X) may grant resources for initiating or continuation an additional random access procedure (e.g., Msg X may grant resources for transmitting another random access message such as Msg 1). If a UE 115 receives a random access response 325 (e.g., Msg X), the UE 115 may randomly select a preamble and transmit a random access message 330 (e.g., for contention resolution). In some examples, a random access message 330 may be the same as or similar to a Msg 1 or a Msg A. For example, the UE may select a preamble (e.g., corresponding to the resources indicated by the Msg X) and may transmit a random access message 330, which may be similar to Msg 1 (e.g., may correspond to a selected preamble, CS, root, etc.). In some examples, a random access message 330 may be referred to as a Msg Y, a random access message 335 (e.g., which may be similar to a Msg 2 or Msg B) may be referred to as a Msg Y2. In the case of a four-step random access procedure, a random access message 340 may be referred to as a Msg Y3, and a random access message 345 (e.g., a contention resolution message, random access message 345-a, random access message 345-b) may referred to as a Msg Y4.

The network may therefore perform contention resolution procedures may transmitting a random access response 310 to a UE 115-c (e.g., for which no collision is detected), and may transmit a random access response 325 to UEs 115 for which contention is detected. The network entity 105-b may transmit the random access response 325-a (e.g., a Msg X) to the UE 115-d (e.g., granting a first set of resources for a random access message 330-a), and may transmit a random access response 325-b (e.g., a Msg X) to the UE 115-e (e.g., granting the same set of resources, or different resources, for a random access message 330-b). The UE 115-d may select a preamble and may transmit the random access message 330-a (e.g., Msg Y) as indicated by the random access response 325-a, and the UE 115-e may select a preamble and transmit the random access message 330-b (e.g., Msg Y) as indicated by the random access response 325-b. The network entity 105-b may transmit the random access message 335-a (e.g., Msg Y2) to the UE 115-d and may transmit the random access message 335-b (e.g., Msg Y2) to the UE 115-e. The UE 115-d may transmit the random access message 340-a via resources indicated by the random access message 335-a, and the UE 115-e may transmit the random access message 340-b via resources indicated by the random access message 335-b. The network entity 105-b may transmit the random access message 340-a to the UE 115-d, and the network entity 105-b may transmit the random access message 340-b to the UE 115-e.

In some examples, detected paths may occur within a threshold duration (e.g., a CS step size, an RTT threshold, a max RTT duration of the cell) of each other, and the network entity 105-b may not be able to effectively determine whether a collision has occurred. The threshold duration may be defined by or based on a threshold (e.g., maximum) RTT within the cell. In some examples, the threshold duration may be greater than the RTT. For example, the threshold duration may be selected such that it covers the threshold (e.g., maximum) RTT of a cell. In some examples, a first CS offset may be selected to be smaller than the threshold duration (e.g., the UE may not have access to information indication the RTT for the UE, and may randomly select the CS offset to be smaller than the threshold RTT). The network entity 105-b may determine that, because the detected paths occur within the threshold duration of each other, there is a collision (e.g., because the network entity 105-b does not have access to a translated time (CS offset and propagation time) of each random access message according to a UE CS dither).

In some cases, one or both UEs 115 may be able to effectively determine accurate timing. For example, the network entity 105-b may detect two paths corresponding to UE 115-d and UE 115-e, with a delay difference of less than a threshold duration. The UE 115-d, however, may detect a single path (e.g., its own path) within the threshold duration from its transmission of the preamble (e.g., via Msg 1), and it can accurately detect the timing. Additionally, the UE 115-e may detect two paths (e.g., the path corresponding to the UE 115-d and its own path) within the threshold duration from its transmission of the preamble and may benefit from (e.g., rely on) a transmission of a Msg Y for accurate timing detection. In some cases, the network entity 105-b may transmit multiple response messages to each UE 115 (e.g., a Msg 2 and a Msg X) for collision resolution that allocate multiple resource sets for each UE 115 (e.g., resources for both a Msg 3 and/or a Msg Y). However, such techniques may result in redundant resource consumption increase (e.g., a wastage of resources) reducing the spectral efficiency of the system.

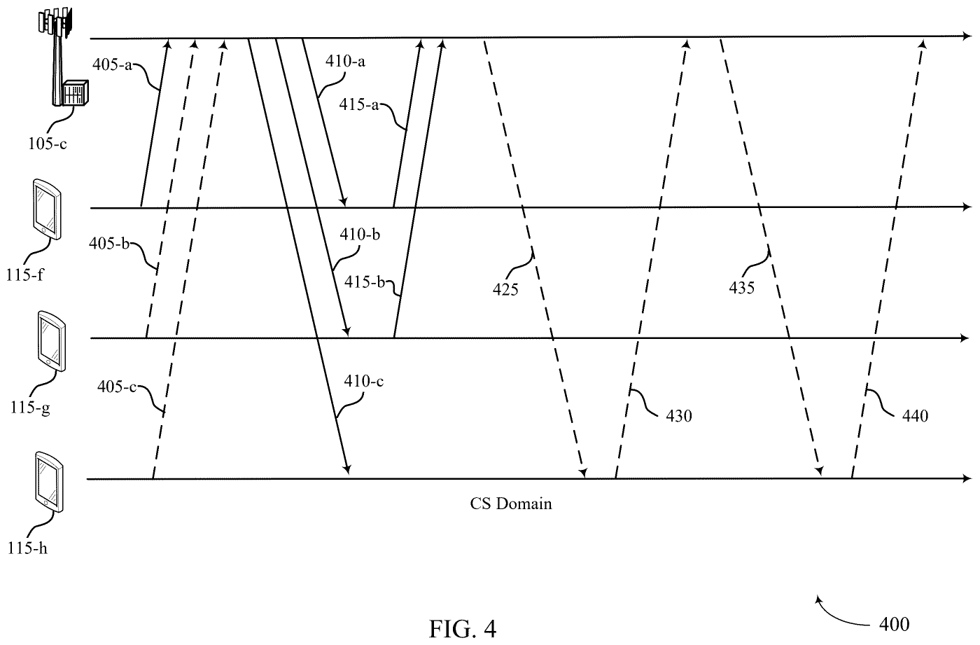

As described herein, and in greater detail with reference to FIG. 4-6, the network entity 105-b may transmit a response message (e.g., Msg 2) to each UE 115. The response message may include an indication of one or more detected paths by the network entity 105-b, which the UEs 115 may use to determine (e.g., identify, ascertain) whether a collision occurred with other detected paths and whether to transmit a random access message (e.g., Msg 3) or refrain from transmitting the message until after it receives a subsequent response message (e.g., Msg X) from the network entity 105-b.

FIG. 4 shows an example of a timeline 400 that supports random access message transmission schemes with cyclic shift in accordance with one or more aspects of the present disclosure. The timeline 400 may implement, or be implemented by, aspects of the wireless communications system 100, the wireless communications system 200, and the timeline 300. For example, one or more network entities 105 (e.g., the network entity 105-c) and one or more UEs 115 (e.g., the UE 115-f, the UE 115-g, and the UE 115-h), which may be examples of corresponding devices described with reference to FIG. 1-3, may communicate in accordance with the timeline 400. Although illustrated with reference to a four-step random access procedure, techniques described herein may be similarly applied to any random access procedure (e.g., a two-step random access procedure).

In some examples, the UE 115-f, the UE 115-g, and the UE 115-h may all transmit a random access message 405 (e.g., Msg 1) via a same RO. Two or more of the UEs 115 may select a same preamble (e.g., and may apply CS dithering to the selected CS). For example, the UE 115-g and the UE 115-h may select the same preamble for the transmission of the random access message 405-b and the random access message 405-c respectively. The UE 115-f may select a different preamble for the transmission of the random access message 405-a. The network entity 105-c may detect each path associated with the UEs 115 (e.g., three random access paths) and determine that the UE 115-f has no collision with the other UEs 115. However, the network entity 105-c may not be able to determine whether a collision occurs between the detected paths associated with the UE 115-g and the UE 115-h (e.g., based on their corresponding paths being detected within a threshold duration of each other).

Due to the uncertainty in determining preamble collision at the network entity 105-c, the network entity 105-c may allocate resources for a random access message 415 (e.g., Msg 3 resources) for each of the detected (e.g., estimated) random access paths and may indicate the allocation via a transmission of a response message 410 (e.g., Msg 2, a random access response) to each of the UEs 115. Various techniques may be supported by the network entity 105-c for determining an allocation of Msg 3 resources for a detected path, including various techniques. For example, the network entity 105-c may allocate Msg 3 resources based on static scheduling (e.g., an indication of resources to use from a predefined set) or dynamic scheduling (e.g., specific resource allocation included in the Msg 2), among other example techniques. Each of the response messages 410 may include other information associated with one or more estimated random access paths, such as an indication of the random access paths detected by the network entity 105-c (e.g., based on receiving the random access messages 405).

Based on receiving the response message 410, each UE 115 may determine if a collision occurs based on the detected paths (e.g., indicated via the response messages 410). In some examples, a UE 115 may transmit a response message 425 (e.g., a random access response) if there no collision is detected. If a collision is detected, the UE 115 may refrain from transmitting the one or more response messages 425 (e.g., may remain silent during Msg 3 transmission resource. That is, each UE 115 may receive an allocation for a Msg 3 transmission and may utilize the allocation when a single path (e.g., its own path) is identified by a response message 410.

For example, the network entity 105-c may transmit a response message 410-a to the UE 115-f, a response message 410-b to the UE 115-g, and a response message 410-c to the UE 115-h. The UE 115-f may determine that it does not collide with the other UEs 115 based on its selection of a different preamble and may transmit the random access message 415-a. The UE 115-g may determine that it does not collide with the other UEs 115 based on the response message 410-b indicating a single detected path and may transmit the random access message 415-b. The response message 410-c, however, may indicate two or more detected paths, and thus the UE 115-h may not transmit a random access message 415.

In some examples, the network entity 105-c may subsequently determine whether one or more collisions occurred on the random access messages 405 based on the responses (e.g., the random access message 415) from the UEs 115. That is, the network entity 105-c may transmit one or more response messages 425 (e.g., one or more transmissions of Msg X) to one or more UEs 115 based on whether the network entity 105-c receives a random access message 415 from the one or more UEs 115. For example, the network entity 105-c may transmit a Msg X for each detected path for which there is no associated Msg 3 transmission (e.g., and may not transmit a Msg X otherwise).

For example, after receiving the random access message 415-b from the UE 115-g and failing to receive a random access message 415 from the UE 115-h, the network entity 105-c may determine (e.g., know, become aware) that a collision occurred at the UE 115-h (e.g., and not at the UE 115-f or the UE 115-g). Accordingly, the network entity 105-c may transmit one or more response messages 425 (e.g., Msg X) to the UE 115-h. As described herein, a Msg X may grant (e.g., schedule, allocate) resources for transmitting a random access message 430 (e.g., a Msg Y, which may correspond to another Msg 1). For example, the response message 425 may indicate a set of resources (e.g., different from the resources indicated via the response message 410-c) for transmitting the random access message 430. In some examples, the UE 115-f and the UE 115-g may proceed with a random access procedure by exchanging further signaling (not shown) to establish respective connections with the network entity 105-c (e.g., by transmitting Msg 3, receiving a fourth message (Msg 4), or communicating other messages).

In some examples, the UE 115-h may transmit the random access message 430 based on receiving the one or more response messages 425, and the random access message 430 may include another preamble selected by the UE 115-h to initiate access with a cell of the network entity 105-c. The network entity 105-c may receive the random access message 430 and may transmit a response message 435 (e.g., a Msg Y2, a random access response message), which may allocate resources for transmission of a random access message 440 (e.g., a Msg Y3, which may correspond to another Msg 3). The UE 115-h may receive the response message 435 and may transmit the random access message 440 accordingly.

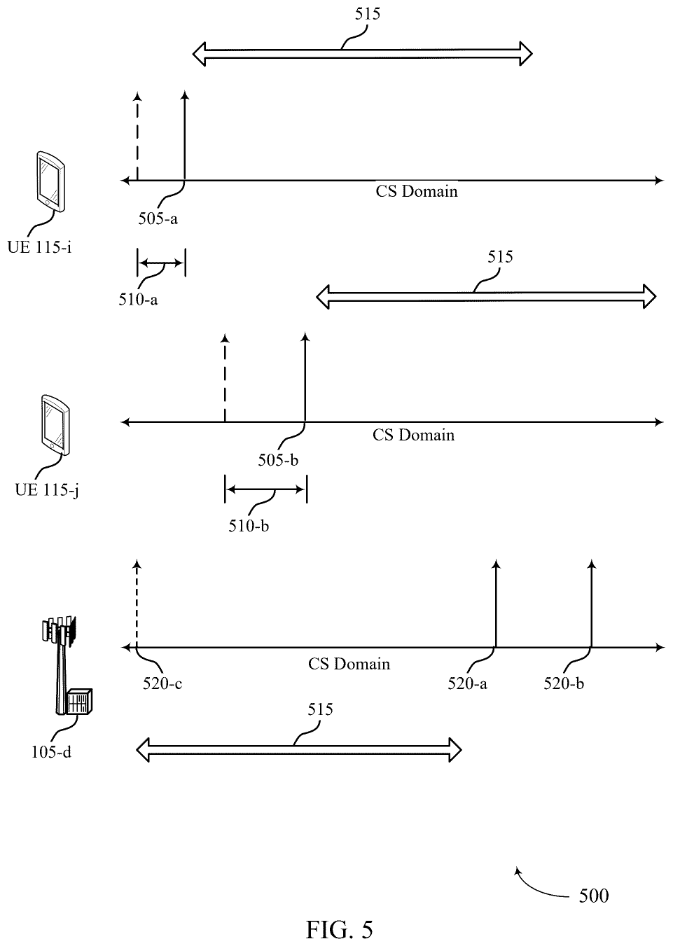

FIG. 5 shows an example of a random access scheme 500 that supports random access message transmission schemes with cyclic shift in accordance with one or more aspects of the present disclosure. The random access scheme 500 may implement, or be implemented by, aspects of the wireless communications system 100, the wireless communications system 200, the timeline 300, and the timeline 400. For example, one or more network entities (e.g., the network entity 105-d), and one or more UEs (e.g., the UE 115-i and the UE 115-j), which may be examples of corresponding devices described with reference to FIG. 1-4, may communicate according to the random access scheme 500. Although illustrated with reference to a four-step random access procedure, techniques described herein may be similarly applied to any random access procedure (e.g., a two-step random access procedure).

Each UE 115 may randomly select a preamble, and may apply a random dithering for transmitting a random access message (e.g., Msg1). For example, the UE 115-i may select a preamble and a CS, and may apply a CS dithering 510-a to the random access message 505-a. The UE 115-j may similarly select a preamble, and may apply a CS dithering 510-b to the random access message 505-b. In some examples, the UEs 115 may select the same preamble and CS, which has the potential to result in a collision.

The network entity 105-d may detect multiple random access paths 520 (e.g., based on or from the received Msg 1 signals). For example, the network entity 105-d may detect the random access path 520-a and the random access path 520-b. In some examples, the network entity 105-d may determine a potential collision between random access paths 520. For instance, the network entity 105-d may determine that the random access path 520-a and the random access path 520-b are detected within an offset that is less than a threshold duration 515 (e.g., which may be based on or equivalent to a RTT for the cell associated with the network entity 105-d, a CS step size). The network entity 105-d may allocate (e.g., reserve, schedule) resources for transmission of a random access message (e.g., Msg 3 resources,) by each UE via its respective path 520. That is, the network entity 105-d may allocate Msg 3 resources to the one or more detected paths for which the network entity 105-d detects that there is no preamble collision or for which the network entity 105-d is uncertain whether a preamble collision occurs (e.g., for detected paths that are within the threshold duration 515 of each other in the CS domain).

For example, the network entity 105-d may determine that there is no collision for a random access path 520-c (which may be associated with a UE 115 that is not shown) as the network entity 105-d may detect that no other multiple random access paths 520 are located within the threshold duration 515 of the random access path 520-c. However, the network entity 105-d may be uncertain whether a collision occurs between the random access path 520-a and the random access path 520-b (e.g., may be unable to accurately determine a timing difference at the corresponding UEs 115). Accordingly, in such examples, the network entity 105-d may allocate resources for a random access message (e.g., Msg 3 resources) for the random access path 520-a, the random access path 520-b, and the random access path 520-c. The network entity 105-d may transmit one or more response messages (e.g., Msg 2) that includes a list of estimated paths (e.g., a list of detected CS for a given root, the random access path 520-a, the random access path 520-b, and the random access path 520-c), estimated CS (e.g., corresponding to the random access message 505-a, the random access message 505-b, or both), the resources for transmitting Msg 3 (e.g., for each estimated random access path 520, for each detected CS). In some examples, the response message may, additionally, or alternatively, include a transmit power control command for each random access path 520.

The UE 115-i and the UE 115-j may receive the list of detected paths, estimated CS, and Msg3 resources for each detected path via respective response messages. Each UE 115 may determine if any of the list of estimated random access paths 520 indicated in the response message occur within the threshold duration 515 (e.g., within a max RTT of a preamble CS plus the dithering 510). For example, the UE 115-i may receive the response message, and may determine that only the random access path 520-a occurs within the threshold duration 515 from the preamble CS plus the dithering 510-a (e.g., from the random access message 505-a). In such examples, the UE 115-i may then calculate (e.g., compute, determine) a timing advance based on a difference between the detected random access path 520-a and its preamble CS plus the dithering 510-a, and may transmit the random access message (e.g., Msg 3) with the resources allocated for the detected path 520-a.

The UE 115-j may receive the response message, and may determine that multiple random access paths 520 (e.g., both the random access path 520-a and the random access path 520-b) occur within the threshold duration 515 from the preamble CS plus the dithering 510-b (e.g., from the random access message 505-b). In such examples, the UE 115-j may refrain from transmitting a random access message (e.g., remain silent during Msg 3 transmission resources). That is, although the UE 115-j may have received an allocation of resources for transmitting Msg 3, the UE 115-j may elect to forego one or more transmissions during such resources.

The network entity 105-d may receive one or more random access messages (e.g., Msg 3) in response to the response messages transmitted by the network entity 105-d. Accordingly, based on the received random access messages, the network entity 105-d may determine (e.g., with increased accuracy) whether a collision may occur on the preamble transmissions (e.g., Msg 1). In some examples, if network entity 105-d receives Msg 3 transmissions from each of the detected random access paths 520 (e.g., based on Msg 1 transmissions) then the network entity 105-d may determine that no collision occurred (e.g., in Msg 1 transmissions). Alternatively, in some examples, If network entity 105-d does not receive Msg 3 transmissions in the allocated resources for one or more detected paths 520, then the network entity 105-d may determine that a collision occurred for the one or more detected paths 520 (e.g., in the Msg 1 transmissions). For example, the network entity 105-d may receive a random access message from the UE 115-i and may fail to receive a random access message from the UE 115-j.

In some examples, the network entity 105-d may transmit one or more second response messages (e.g., a Msg X) to each random access path 520 for which the network entity 105-d determines that a collision occurred (e.g., random access path 520-b). That is, the network entity 105-d may transmit a Msg X to the UE 115-j, which may include a second set of resources for transmitting a second random access message (e.g., a Msg Y). Accordingly, based on one or more transmissions of the second response message, colliding UEs 115 (e.g., the UE 115-j) may transmit a Msg Y, may receive a corresponding Msg Y2, transmit a corresponding Msg Y3, and receive a corresponding Msg Y4, which may complete a connection establishment process with the cell of the network entity 105-d. In some examples, the one or more second response messages may include a list of estimated paths (e.g., a list of detected CS for a given root), and the resources for transmitting a Msg Y (e.g., including resource allocations for a single RO, for multiple ROs, or both).

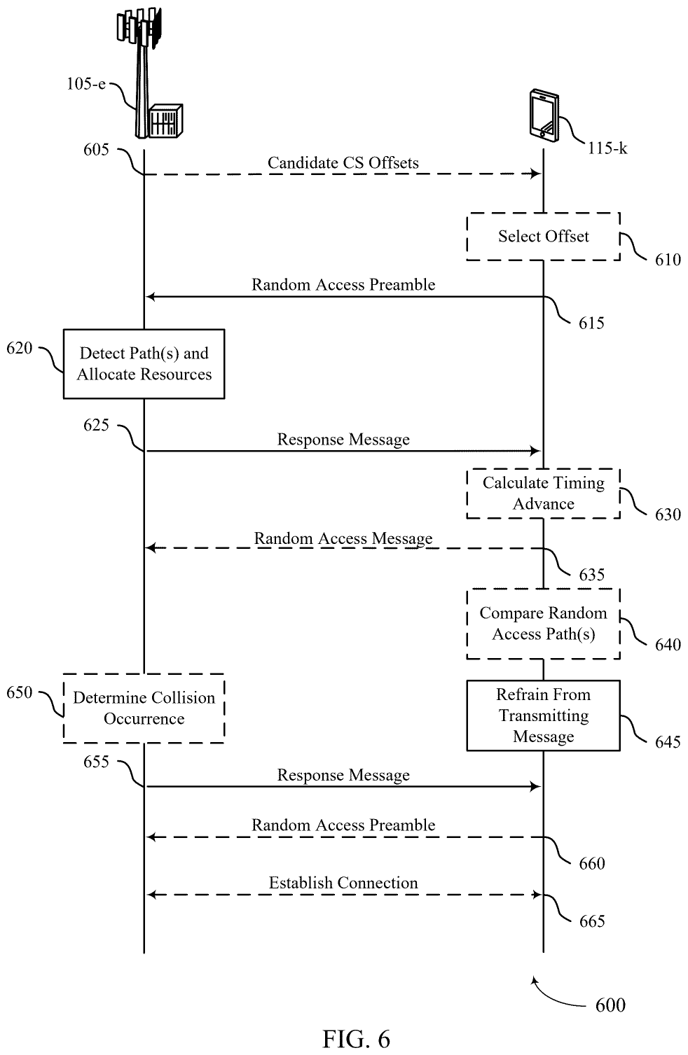

FIG. 6 shows an example of a process flow 600 that supports random access message transmission schemes with cyclic shift in accordance with one or more aspects of the present disclosure. The process flow 600 may implement, or be implemented by, aspects of the wireless communications system 100, the wireless communications system 200, the timeline 300, the timeline 400, and the random access scheme 500. For example, the process flow 600 may include one or more network entities 105 (e.g., network entity 105-e), and one or more UEs 115 (e.g., UE 115-k), which may be examples of corresponding devices described with reference to FIG. 1-5 and may communicate according to the process flow 600. Although illustrated with reference to a four-step random access procedure, techniques described herein may be similarly applied to any random access procedure (e.g., a two-step random access procedure).

Alternative examples of the following may be implemented. For example, some steps may be performed in a different order than described or may not be performed at all. In some implementations, steps may include additional features not mentioned below, or further steps may be added. Further, although the UE 115 and the network entity 105 are shown performing the operations of the process flow 600, some aspects of some operations may also be performed by one or more other wireless communication devices.

At 605, the UE 115-k may receive an indication of a set of candidate CS offsets, which may be output by the network entity 105-e. In some examples, the UE 115-e may additionally, or alternatively, receive an indication of a set of candidates CSs (e.g., associated with one or more sequence roots) from the network entity 105-e (e.g., the network entity 105-e may perform an overprovision of the CSs and CS offsets that are available for selection by the UE 115-k). The UE 115-k may use the set of candidate CSs, the set of candidate CS offsets, or both to generate a preamble for a Msg 1 transmission.

At 610, the UE 115-k may select a CS offset from the set of candidate CS offsets. In some examples, the selection may be based on a pseudo-random function (e.g., such as CS dithering). Additionally, or alternatively, selecting the CS offset from the set of candidate CS offsets based on receiving one or more indications (e.g., the indication at 605). Accordingly, in some examples, transmitting a random access preamble may be based on selecting the CS offset.

At 615, the UE 115-k may transmit a random access preamble via an RO (e.g., via a Msg 1 transmission using the RO resources), which may be obtained by the network entity 105-e. The random access preamble may be transmitted in accordance with a CS (e.g., a selected CS, a computed CS) of a set of candidate CSs and with a CS offset (e.g., a selected CS offset, a computed CS offset) of a set of candidate CS offsets.

At 620, the network entity 105-e may detect (e.g., estimate) one or more random access paths based on receiving one or more random access preamble transmissions. For example, the network entity 105-e may detect a first random access path (e.g., associated with a first UE 115), a second random access path (e.g., associated with a second UE 115), and/or a third random access path (e.g., associated with a third UE 115) based on one or more transmissions of a first random access preamble obtained during a first RO. In some examples, the network entity 105-e may allocate (e.g., prior to outputting a first response message) a first set of resources for transmitting a random access message for each of the detected random access paths. In some examples, each first set of resources may include one or more second ROs associated with a first random access procedure performed by the network entity 105-e and one or more UEs (e.g., the UE 115-k).

At 625, the UE 115-k may receive (e.g., based on transmitting the random access preamble) a first response message (e.g., Msg 2, a random access response), which may be output by the network entity 105-e based on detecting a path associated with the UE 115-k and allocation resources for the UE 115-k. In some examples, the first response message may indicate information associated with one or more estimated random access paths corresponding to one or more random access preambles received by the network entity 105-e within a duration (e.g., all paths detected by the network entity 105-e within a max RTT duration associated with a cell of the network entity 105-e). In some examples, the information may include an indication of a set of resources for transmitting a random access message of a random access procedure. In some examples, the information may further include a transmit power control command for each random access path of the one or more estimated random access paths.

In some examples, the UE 115-k may receive, via the first response message, an indication of one or more detected CSs that are detected by the network entity within the duration (e.g., the max RTT). In some examples, each of the one or more detected CSs may correspond to a respective estimated random access path of the one or more estimated random access paths.

At 630, in some examples (e.g., when a single estimated random access path is detected, by the UE 115-k, within a threshold duration of the CS and the CS offset), the UE 115-k may calculate a timing advance. For example, the UE 115-k may calculate the timing advance based on a difference (e.g., based on computing the difference) between a detected CS (e.g., indicated by the network entity 105-e) and the CS and the CS offset (e.g., the CS and offset selected by the UE 115-k) used for transmitting the random access preamble. In some examples, a threshold duration (e.g., used by the UE 115-k and the network entity 105-e to identify potential collisions) may be associated with an RTT between a serving cell (e.g., associated with the network entity 105-e) and the UE 115-k.

At 635, in some examples (e.g., when a single estimated random access path indicated by the first response message is detected within the threshold duration of the CS and the CS offset), the UE 115-k may transmit the random access message (e.g., Msg 3), which may be obtained by the network entity 105-e. That is, the UE 115-k may determine that no collisions occurred with other UEs 115 and may accordingly proceed with the random access procedure by transmitting the Msg 3). In some examples, transmitting the random access message may be based on calculating the timing advance. Additionally, or alternatively, the random access message is transmitted in accordance with the transmit power control command. wherein the threshold duration is associated with a round trip time (RTT) between a serving cell and the UE.

At 640, in some examples, the UE 115-k may compare each of the one or more estimated random access paths (e.g., received via the Msg 2) to the threshold duration (e.g., a max RTT that begins at its own Msg 1 transmission), which may enable the UE 115-k to determine whether any collisions occur). In some examples, the UE 115-k may detect a quantity of the one or more estimated random access paths within the threshold duration of the CS and the CS offset based on the comparing.

At 645, the UE 115-k may refrain from refraining from transmitting a random access message (e.g., a Msg 3). For example, when two or more estimated random access paths (e.g., indicated by the first response message) are detected within a threshold duration of its own CS and CS offset, the UE 115-k may determine that a collision occurs with at least one other random access path. Accordingly, the UE 115-k indicates the collision by refraining from transmission Msg 3. That is, the network entity 105-e may be configured to determine collision occurrences based on an absence of a Msg 3.

At 650, in some examples, the network entity 105-e may determine whether any collisions occur at the one or more UEs that receive the transmitted response messages (e.g., Msg 2). For example, the network entity 105-e may determine that a collision occurred between a first random access path and a second random access path based on failing to receive at least on random access message (e.g., a Msg 3). Accordingly, the network entity 105-e may proceed to output additional response messages (e.g., Msg X) based on determining that the collision occurred.

At 655, the UE 115-k may receive, based on refraining from transmitting the random access message (e.g., based on remaining silent during Msg 3 transmission resources), a second response message (e.g., a Msg X, a random access response), which may be output by the network entity 105-e. The second response message may include second information that indicates a second set of resources (e.g., one or more ROs) for transmitting a second random access preamble (e.g., a Msg Y) associated with a second random access procedure (e.g., including communication of Msg X, Msg Y, Msg Y2, and Msg Y3, which may correspond to a second iteration of a Msg 1, Msg 2, Msg 3, and Msg 4).

At 660, the UE 115-k may transmit another random access message (e.g., a Msg Y), which may include second random access preamble, to the network entity 105-e. In some examples, the UE 115-k may transmit the second random access preamble in accordance with (e.g., utilizing) a second RO indicated by the second set of resources based on receiving the second response message (e.g., Msg X). In some examples, the network entity 105-e may respond to the second random access preamble with a subsequent response message (e.g., Msg Y2), and the UE 115-k may subsequently transmit another random access message (e.g., Msg Y3), which may complete a random access procedure.

At 665, the UE 115-k may establish a connection with a serving cell of the network entity 105-e. In some examples, the UE 115-k may establish the connection based on receiving the third response message (e.g., Msg X, Msg Y2) and transmitting another random access message (e.g., Msg Y, Msg Y3) based on (e.g., in response to) receiving the third response message. That is, the UE 115-k may complete a random access procedure in accordance with one or more techniques described herein, and may establish the connection with the serving cell of the network entity 105-e based on completing the random access procedure.

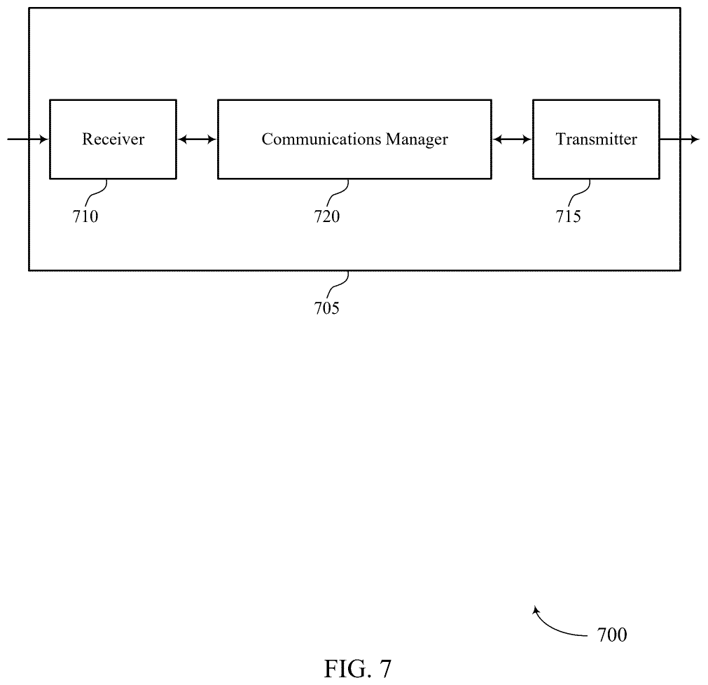

FIG. 7 shows a block diagram 700 of a device 705 that supports random access message transmission schemes with cyclic shift in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques.

Each of these components may be in communication with one another (e.g., via one or more buses).

The receiver 710 may provide a means for receiving information such as packets, user data, control information, or any combination thereof associated with various information channels (e.g., control channels, data channels, information channels related to random access message transmission schemes with cyclic shift). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to random access message transmission schemes with cyclic shift). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of random access message transmission schemes with cyclic shift as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting a random access preamble via a random access occasion in accordance with a cyclic shift of a set of candidate cyclic shifts and with a cyclic shift offset of a set of candidate cyclic shift offsets. The communications manager 720 is capable of, configured to, or operable to support a means for receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The communications manager 720 is capable of, configured to, or operable to support a means for refraining from transmitting the random access message when two or more estimated random access paths indicated by the first response message are detected within a threshold duration of the cyclic shift and the cyclic shift offset. The communications manager 720 is capable of, configured to, or operable to support a means for receiving, based on refraining from transmitting the random access message, a second response message including second information indicating a second set of resources for transmitting a second random access preamble associated with a second random access procedure.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, more efficient utilization of communication resources, among other benefits.

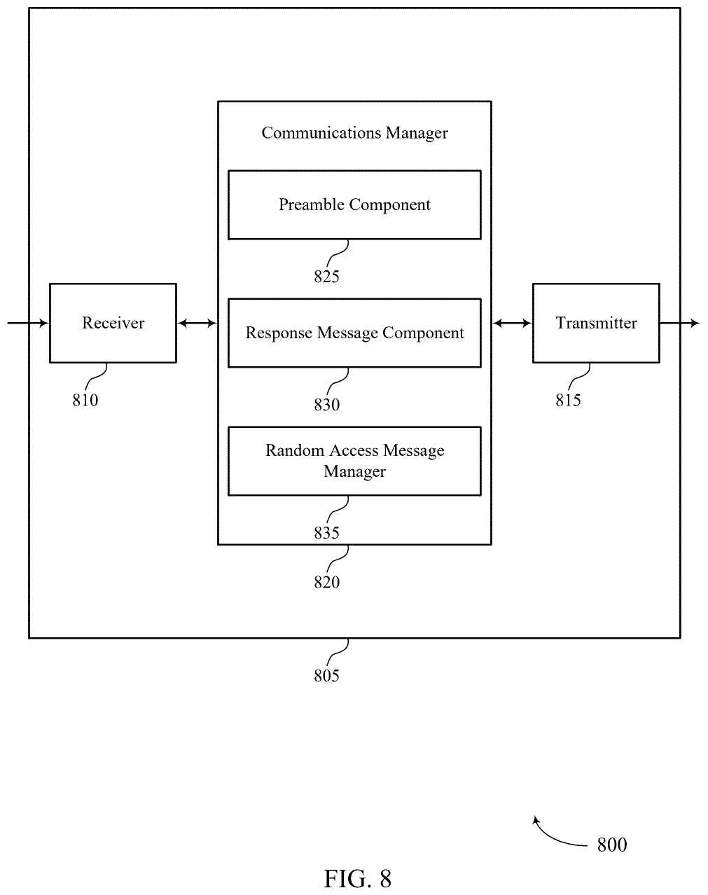

FIG. 8 shows a block diagram 800 of a device 805 that supports random access message transmission schemes with cyclic shift in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to random access message transmission schemes with cyclic shift). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to random access message transmission schemes with cyclic shift). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of random access message transmission schemes with cyclic shift as described herein. For example, the communications manager 820 may include a preamble component 825, a response message component 830, a random access message manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The preamble component 825 is capable of, configured to, or operable to support a means for transmitting a random access preamble via a random access occasion in accordance with a cyclic shift of a set of candidate cyclic shifts and with a cyclic shift offset of a set of candidate cyclic shift offsets. The response message component 830 is capable of, configured to, or operable to support a means for receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The random access message manager 835 is capable of, configured to, or operable to support a means for refraining from transmitting the random access message when two or more estimated random access paths indicated by the first response message are detected within a threshold duration of the cyclic shift and the cyclic shift offset. The response message component 830 is capable of, configured to, or operable to support a means for receiving, based on refraining from transmitting the random access message, a second response message including second information indicating a second set of resources for transmitting a second random access preamble associated with a second random access procedure.

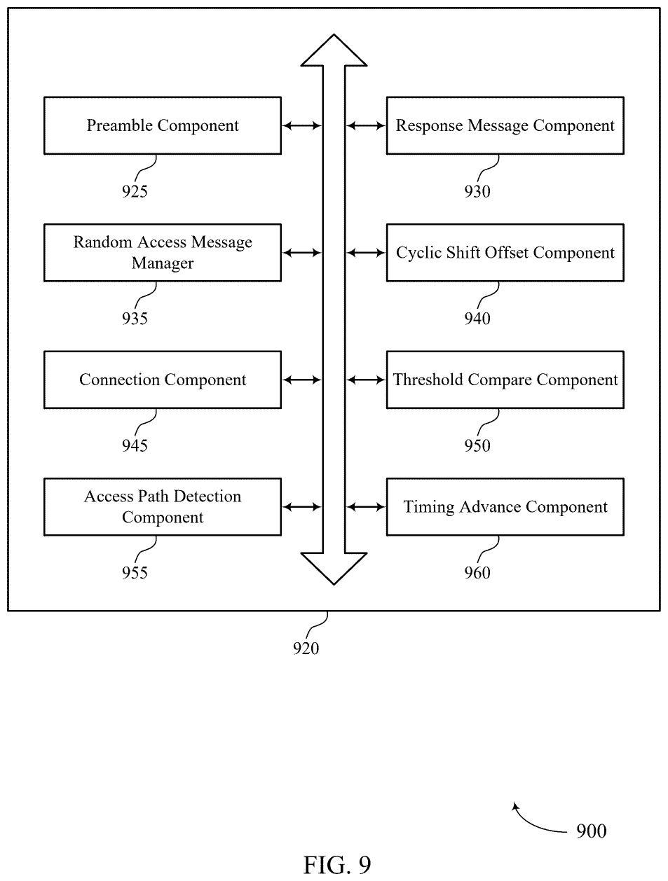

FIG. 9 shows a block diagram 900 of a communications manager 920 that supports random access message transmission schemes with cyclic shift in accordance with one or more aspects of the present disclosure. The communications manager 920 may be an example of aspects of a communications manager 720, a communications manager 820, or both, as described herein. The communications manager 920, or various components thereof, may be an example of means for performing various aspects of random access message transmission schemes with cyclic shift as described herein. For example, the communications manager 920 may include a preamble component 925, a response message component 930, a random access message manager 935, a cyclic shift offset component 940, a connection component 945, a threshold compare component 950, an access path detection component 955, a timing advance component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The preamble component 925 is capable of, configured to, or operable to support a means for transmitting a random access preamble via a random access occasion in accordance with a cyclic shift of a set of candidate cyclic shifts and with a cyclic shift offset of a set of candidate cyclic shift offsets. The response message component 930 is capable of, configured to, or operable to support a means for receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The random access message manager 935 is capable of, configured to, or operable to support a means for refraining from transmitting the random access message when two or more estimated random access paths indicated by the first response message are detected within a threshold duration of the cyclic shift and the cyclic shift offset. In some examples, the response message component 930 is capable of, configured to, or operable to support a means for receiving, based on refraining from transmitting the random access message, a second response message including second information indicating a second set of resources for transmitting a second random access preamble associated with a second random access procedure.

In some examples, the cyclic shift offset component 940 is capable of, configured to, or operable to support a means for selecting the cyclic shift offset from the set of candidate cyclic shift offsets based on a pseudo-random function.

In some examples, the cyclic shift offset component 940 is capable of, configured to, or operable to support a means for receiving, prior to transmitting the random access preamble, an indication of the set of candidate cyclic shift offsets. In some examples, the cyclic shift offset component 940 is capable of, configured to, or operable to support a means for selecting the cyclic shift offset from the set of candidate cyclic shift offsets based on receiving the indication, where transmitting the random access preamble is based on selecting the cyclic shift offset.

In some examples, the random access message manager 935 is capable of, configured to, or operable to support a means for transmitting the random access message when a single estimated random access path indicated by the first response message is detected within the threshold duration of the cyclic shift and the cyclic shift offset. In some examples, the response message component 930 is capable of, configured to, or operable to support a means for receiving a third response message based on transmitting the random access message. In some examples, the connection component 945 is capable of, configured to, or operable to support a means for establishing a connection with a serving cell of the network entity based on receiving the third response message.

In some examples, the preamble component 925 is capable of, configured to, or operable to support a means for transmitting the second random access preamble in accordance with a second random access occasion indicated by the second set of resources based on receiving the second response message.

In some examples, the response message component 930 is capable of, configured to, or operable to support a means for receiving a third response message based on transmitting the second random access preamble. In some examples, the random access message manager 935 is capable of, configured to, or operable to support a means for transmitting a second random access message based on receiving the third response message. In some examples, the connection component 945 is capable of, configured to, or operable to support a means for establishing a connection with a serving cell of the network entity based on transmitting the second random access message.

In some examples, the response message component 930 is capable of, configured to, or operable to support a means for receiving, via the first response message, an indication of one or more detected cyclic shifts that are detected by the network entity within the duration, each of the one or more detected cyclic shifts corresponding to a respective estimated random access path of the one or more estimated random access paths.

In some examples, the timing advance component 960 is capable of, configured to, or operable to support a means for calculating, when a single estimated random access path is detected within the threshold duration of the cyclic shift and the cyclic shift offset, a timing advance based on a difference between a detected cyclic shift and the cyclic shift and the cyclic shift offset used for transmitting the random access preamble. In some examples, the random access message manager 935 is capable of, configured to, or operable to support a means for transmitting the random access message based on calculating the timing advance.

In some examples, the information further includes a transmit power control command for each random access path of the one or more estimated random access paths. In some examples, the random access message is transmitted in accordance with the transmit power control command.

In some examples, the threshold compare component 950 is capable of, configured to, or operable to support a means for comparing each of the one or more estimated random access paths to the threshold duration. In some examples, the access path detection component 955 is capable of, configured to, or operable to support a means for detecting a quantity of the one or more estimated random access paths within the threshold duration of the cyclic shift and the cyclic shift offset based on the comparing.

In some examples, the threshold duration is associated with a round trip time (RTT) between a serving cell and the UE.

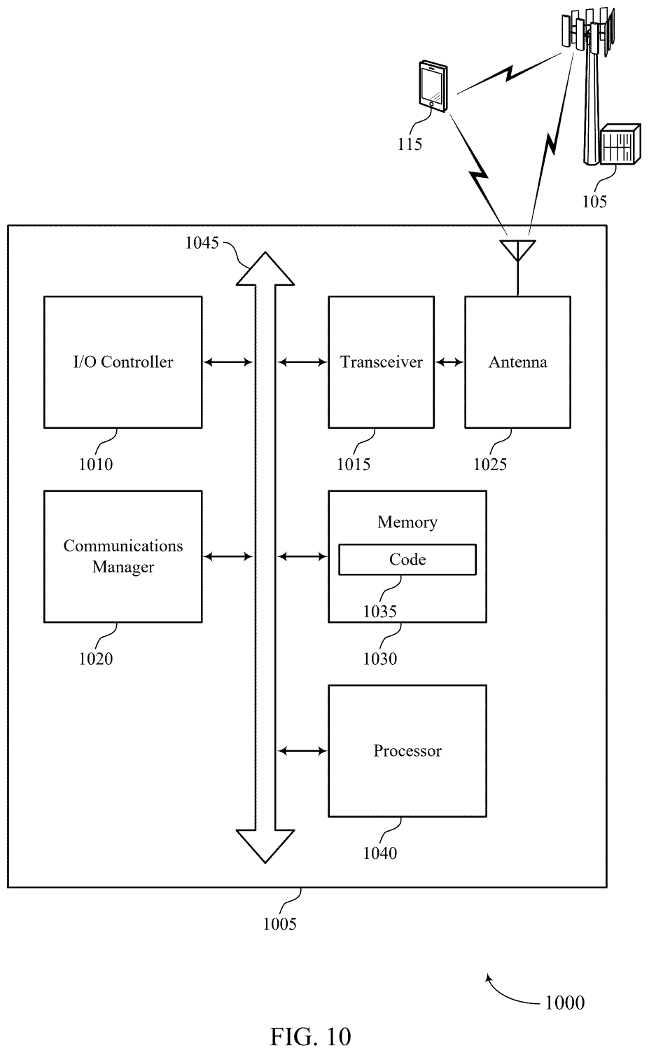

FIG. 10 shows a diagram of a system 1000 including a device 1005 that supports random access message transmission schemes with cyclic shift in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035.

The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting random access message transmission schemes with cyclic shift). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting a random access preamble via a random access occasion in accordance with a cyclic shift of a set of candidate cyclic shifts and with a cyclic shift offset of a set of candidate cyclic shift offsets. The communications manager 1020 is capable of, configured to, or operable to support a means for receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The communications manager 1020 is capable of, configured to, or operable to support a means for refraining from transmitting the random access message when two or more estimated random access paths indicated by the first response message are detected within a threshold duration of the cyclic shift and the cyclic shift offset. The communications manager 1020 is capable of, configured to, or operable to support a means for receiving, based on refraining from transmitting the random access message, a second response message including second information indicating a second set of resources for transmitting a second random access preamble associated with a second random access procedure.

By including or configuring the communications manager 1020 in accordance with examples as described herein, the device 1005 may support techniques for reduced latency, improved user experience related to reduced processing, reduced power consumption, more efficient utilization of communication resources, and improved coordination between devices, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of random access message transmission schemes with cyclic shift as described herein, or the at least one processor 1040 and the at least one memory 1030 may be otherwise configured to, individually or collectively, perform or support such operations.

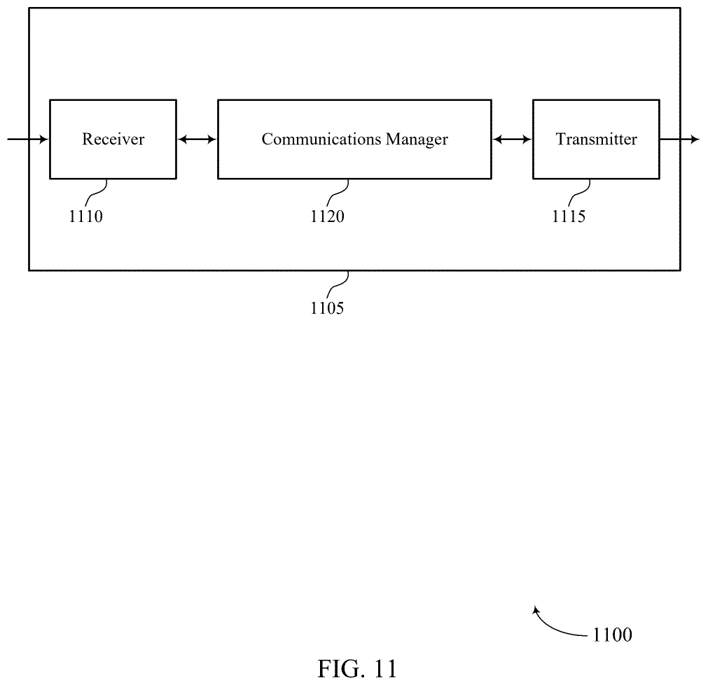

FIG. 11 shows a block diagram 1100 of a device 1105 that supports random access message transmission schemes with cyclic shift in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of random access message transmission schemes with cyclic shift as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for detecting a first random access path and a second random access path based on one or more transmissions of a first random access preamble obtained during a first random access occasion. The communications manager 1120 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a random access message of a first random access procedure. The communications manager 1120 is capable of, configured to, or operable to support a means for obtaining a first random access message associated with the first random access path based on outputting the first response message. The communications manager 1120 is capable of, configured to, or operable to support a means for outputting a second response message associated with the second random access path based on failing to receive a second random access message associated with the second random access path, the second response message including second information associated with a second set of resources for transmitting a second random access preamble associated with a second random access procedure.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources, among other benefits.

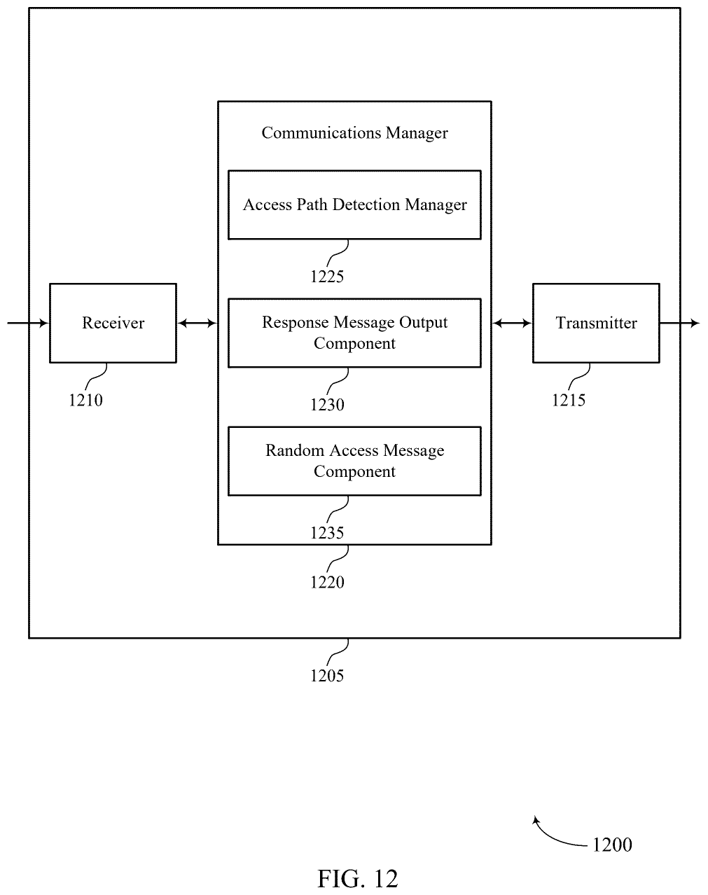

FIG. 12 shows a block diagram 1200 of a device 1205 that supports random access message transmission schemes with cyclic shift in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of random access message transmission schemes with cyclic shift as described herein. For example, the communications manager 1220 may include an access path detection manager 1225, a response message output component 1230, a random access message component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The access path detection manager 1225 is capable of, configured to, or operable to support a means for detecting a first random access path and a second random access path based on one or more transmissions of a first random access preamble obtained during a first random access occasion. The response message output component 1230 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a random access message of a first random access procedure. The random access message component 1235 is capable of, configured to, or operable to support a means for obtaining a first random access message associated with the first random access path based on outputting the first response message. The response message output component 1230 is capable of, configured to, or operable to support a means for outputting a second response message associated with the second random access path based on failing to receive a second random access message associated with the second random access path, the second response message including second information associated with a second set of resources for transmitting a second random access preamble associated with a second random access procedure.

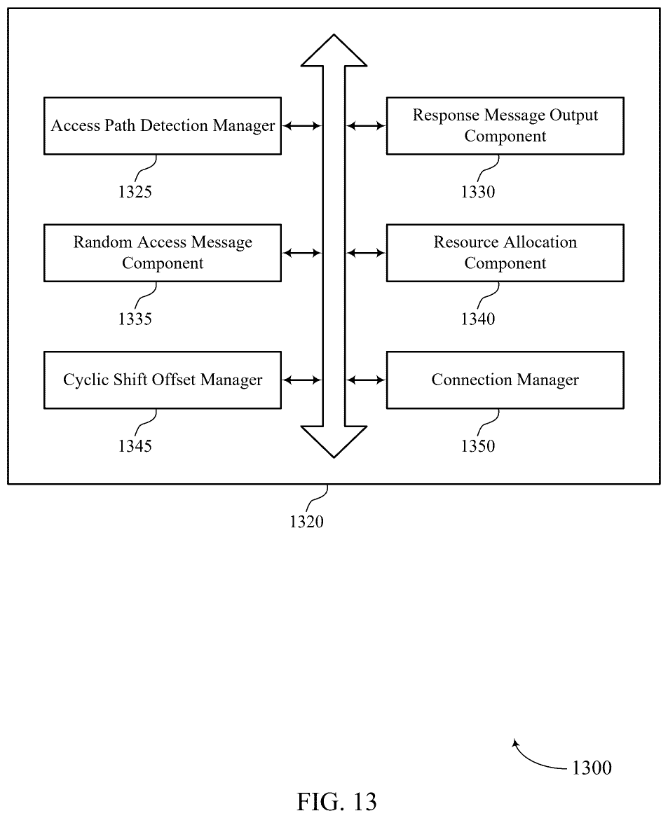

FIG. 13 shows a block diagram 1300 of a communications manager 1320 that supports random access message transmission schemes with cyclic shift in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of random access message transmission schemes with cyclic shift as described herein. For example, the communications manager 1320 may include an access path detection manager 1325, a response message output component 1330, a random access message component 1335, a resource allocation component 1340, a cyclic shift offset manager 1345, a connection manager 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The access path detection manager 1325 is capable of, configured to, or operable to support a means for detecting a first random access path and a second random access path based on one or more transmissions of a first random access preamble obtained during a first random access occasion. The response message output component 1330 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a random access message of a first random access procedure. The random access message component 1335 is capable of, configured to, or operable to support a means for obtaining a first random access message associated with the first random access path based on outputting the first response message. In some examples, the response message output component 1330 is capable of, configured to, or operable to support a means for outputting a second response message associated with the second random access path based on failing to receive a second random access message associated with the second random access path, the second response message including second information associated with a second set of resources for transmitting a second random access preamble associated with a second random access procedure.

In some examples, the resource allocation component 1340 is capable of, configured to, or operable to support a means for allocating, prior to outputting the first response message, the first set of resources for transmitting the random access message, the first set of resources including one or more second random access occasions associated with the first random access procedure.

In some examples, the access path detection manager 1325 is capable of, configured to, or operable to support a means for detecting a third random access path based on the one or more transmissions of the first random access preamble obtained during the first random access occasion. In some examples, the random access message component 1335 is capable of, configured to, or operable to support a means for obtaining a third random access message associated with the third random access path based on outputting the first response message, the third random access message corresponds to a third UE.

In some examples, the random access message component 1335 is capable of, configured to, or operable to support a means for determining that a collision occurred between the first random access path and the second random access path based on failing to receive the second random access message, where outputting the second response message is based on determining that the collision occurred.

In some examples, the cyclic shift offset manager 1345 is capable of, configured to, or operable to support a means for outputting, prior to detecting the first random access path and the second random access path, an indication of a set of candidate cyclic shift offsets, where obtaining the one or more transmissions of the first random access preamble is based on outputting the indication of the set of candidate cyclic shift offsets.

In some examples, the response message output component 1330 is capable of, configured to, or operable to support a means for outputting a third response message based on obtaining the first random access message. In some examples, the connection manager 1350 is capable of, configured to, or operable to support a means for establishing a connection with a first UE associated with the first random access path based on outputting the third response message.

In some examples, the random access message component 1335 is capable of, configured to, or operable to support a means for obtaining the second random access preamble in accordance with the second set of resources based on outputting the second response message. In some examples, the response message output component 1330 is capable of, configured to, or operable to support a means for outputting a third response message based on obtaining the second random access preamble.

In some examples, the random access message component 1335 is capable of, configured to, or operable to support a means for obtaining a third random access message based on outputting the third response message. In some examples, the connection manager 1350 is capable of, configured to, or operable to support a means for establishing a connection with a second UE associated with the second random access path based on obtaining the third random access message.

In some examples, the response message output component 1330 is capable of, configured to, or operable to support a means for outputting, via the first response message, an indication of one or more detected cyclic shifts that are detected by the network entity within the first random access occasion, each of the one or more detected cyclic shifts corresponding to a respective estimated random access path of the one or more estimated random access paths.

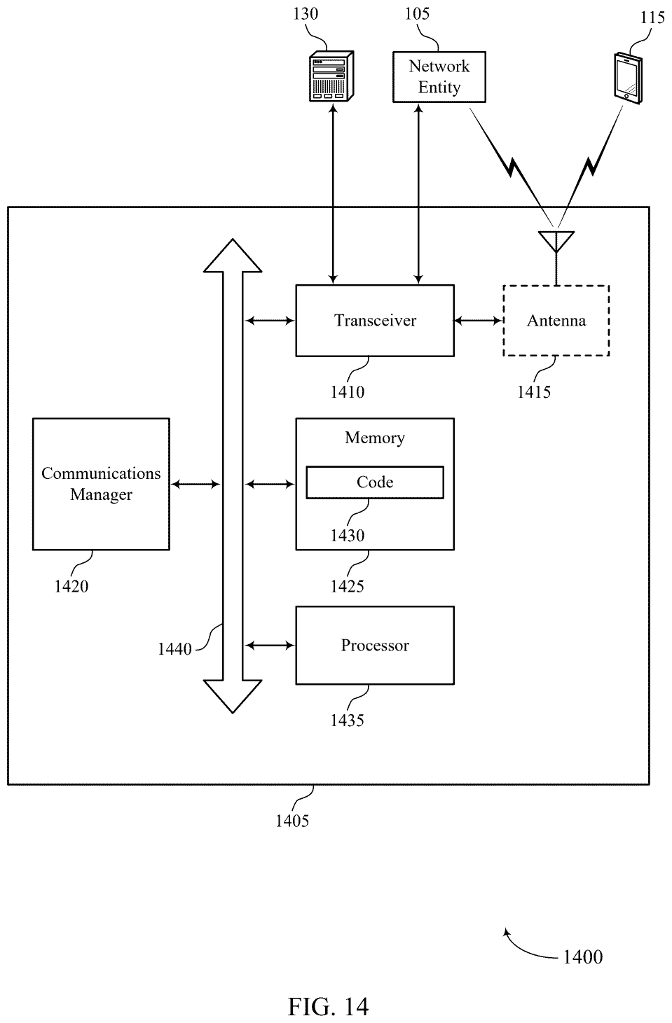

FIG. 14 shows a diagram of a system 1400 including a device 1405 that supports random access message transmission schemes with cyclic shift in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting random access message transmission schemes with cyclic shift). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for detecting a first random access path and a second random access path based on one or more transmissions of a first random access preamble obtained during a first random access occasion. The communications manager 1420 is capable of, configured to, or operable to support a means for outputting, based on detecting the first random access path and the second random access path, a first response message including information associated with one or more estimated random access paths including at least the first random access path and the second random access path, the information including an indication of a first set of resources for transmitting a random access message of a first random access procedure. The communications manager 1420 is capable of, configured to, or operable to support a means for obtaining a first random access message associated with the first random access path based on outputting the first response message. The communications manager 1420 is capable of, configured to, or operable to support a means for outputting a second response message associated with the second random access path based on failing to receive a second random access message associated with the second random access path, the second response message including second information associated with a second set of resources for transmitting a second random access preamble associated with a second random access procedure.

By including or configuring the communications manager 1420 in accordance with examples as described herein, the device 1405 may support techniques for improved communication reliability, reduced latency, improved user experience related to reduced processing, more efficient utilization of communication resources, and improved coordination between devices, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of random access message transmission schemes with cyclic shift as described herein, or the at least one processor 1435 and the at least one memory 1425 may be otherwise configured to, individually or collectively, perform or support such operations.

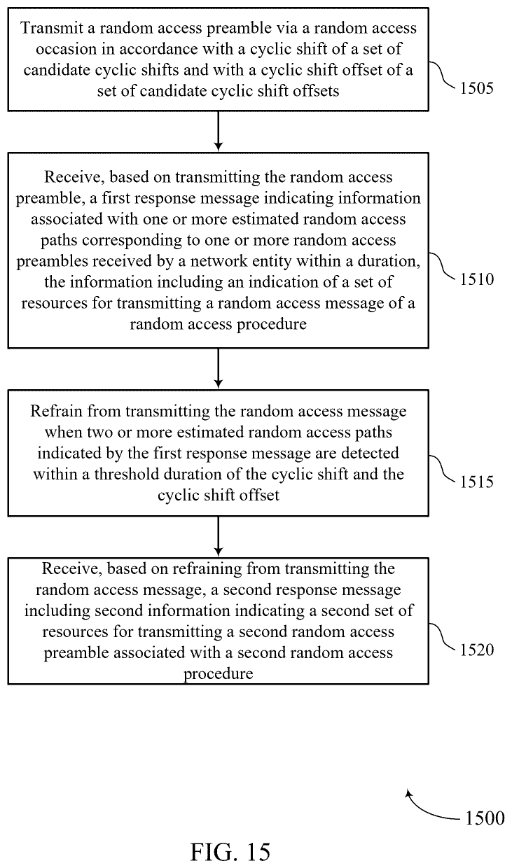

FIG. 15 shows a flowchart illustrating a method 1500 that supports random access message transmission schemes with cyclic shift in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a random access preamble via a random access occasion in accordance with a cyclic shift of a set of candidate cyclic shifts and with a cyclic shift offset of a set of candidate cyclic shift offsets. The operations of 1505 may be performed in accordance with examples as disclosed herein. In some examples, aspects of the operations of 1505 may be performed by a preamble component 925 as described with reference to FIG. 9.

At 1510, the method may include receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The operations of 1510 may be performed in accordance with examples as disclosed herein. In some examples, aspects of the operations of 1510 may be performed by a response message component 930 as described with reference to FIG. 9.

At 1515, the method may include refraining from transmitting the random access message when two or more estimated random access paths indicated by the first response message are detected within a threshold duration of the cyclic shift and the cyclic shift offset. The operations of 1515 may be performed in accordance with examples as disclosed herein. In some examples, aspects of the operations of 1515 may be performed by a random access message manager 935 as described with reference to FIG. 9.

At 1520, the method may include receiving, based on refraining from transmitting the random access message, a second response message including second information indicating a second set of resources for transmitting a second random access preamble associated with a second random access procedure. The operations of 1520 may be performed in accordance with examples as disclosed herein. In some examples, aspects of the operations of 1520 may be performed by a response message component 930 as described with reference to FIG. 9.

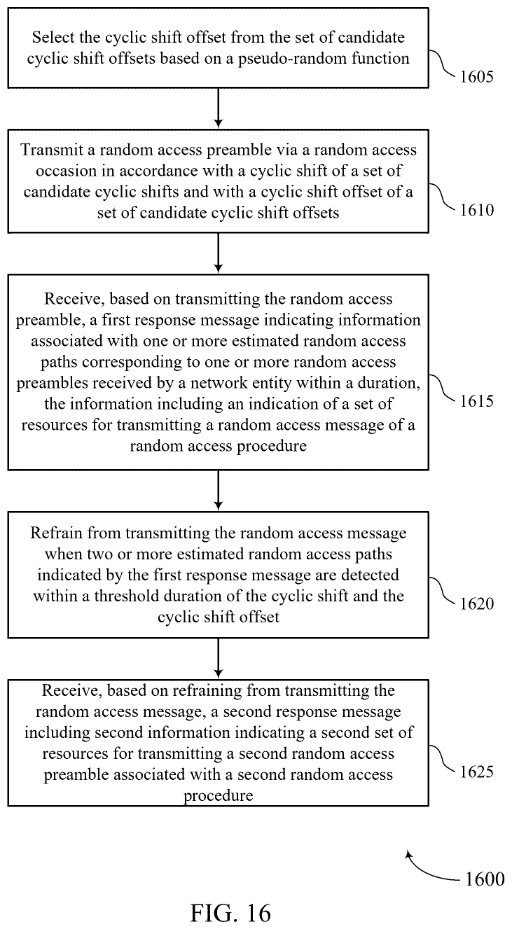

FIG. 16 shows a flowchart illustrating a method 1600 that supports random access message transmission schemes with cyclic shift in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include selecting the cyclic shift offset from the set of candidate cyclic shift offsets based on a pseudo-random function. The operations of 1605 may be performed in accordance with examples as disclosed herein. In some examples, aspects of the operations of 1605 may be performed by a cyclic shift offset component 940 as described with reference to FIG. 9.

At 1610, the method may include transmitting a random access preamble via a random access occasion in accordance with a cyclic shift of a set of candidate cyclic shifts and with a cyclic shift offset of a set of candidate cyclic shift offsets. The operations of 1610 may be performed in accordance with examples as disclosed herein. In some examples, aspects of the operations of 1610 may be performed by a preamble component 925 as described with reference to FIG. 9.

At 1615, the method may include receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The operations of 1615 may be performed in accordance with examples as disclosed herein. In some examples, aspects of the operations of 1615 may be performed by a response message component 930 as described with reference to FIG. 9.

At 1620, the method may include refraining from transmitting the random access message when two or more estimated random access paths indicated by the first response message are detected within a threshold duration of the cyclic shift and the cyclic shift offset. The operations of 1620 may be performed in accordance with examples as disclosed herein. In some examples, aspects of the operations of 1620 may be performed by a random access message manager 935 as described with reference to FIG. 9.

At 1625, the method may include receiving, based on refraining from transmitting the random access message, a second response message including second information indicating a second set of resources for transmitting a second random access preamble associated with a second random access procedure. The operations of 1625 may be performed in accordance with examples as disclosed herein. In some examples, aspects of the operations of 1625 may be performed by a response message component 930 as described with reference to FIG. 9.

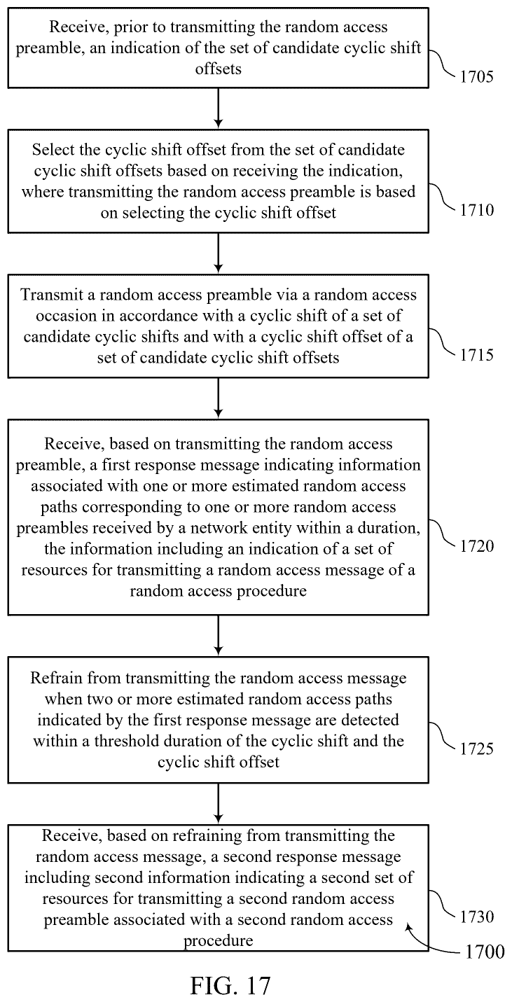

FIG. 17 shows a flowchart illustrating a method 1700 that supports random access message transmission schemes with cyclic shift in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, prior to transmitting the random access preamble, an indication of the set of candidate cyclic shift offsets. The operations of 1705 may be performed in accordance with examples as disclosed herein. In some examples, aspects of the operations of 1705 may be performed by a cyclic shift offset component 940 as described with reference to FIG. 9.

At 1710, the method may include selecting the cyclic shift offset from the set of candidate cyclic shift offsets based on receiving the indication, where transmitting the random access preamble is based on selecting the cyclic shift offset. The operations of 1710 may be performed in accordance with examples as disclosed herein. In some examples, aspects of the operations of 1710 may be performed by a cyclic shift offset component 940 as described with reference to FIG. 9.

At 1715, the method may include transmitting a random access preamble via a random access occasion in accordance with a cyclic shift of a set of candidate cyclic shifts and with a cyclic shift offset of a set of candidate cyclic shift offsets. The operations of 1715 may be performed in accordance with examples as disclosed herein. In some examples, aspects of the operations of 1715 may be performed by a preamble component 925 as described with reference to FIG. 9.

At 1720, the method may include receiving, based on transmitting the random access preamble, a first response message indicating information associated with one or more estimated random access paths corresponding to one or more random access preambles received by a network entity within a duration, the information including an indication of a set of resources for transmitting a random access message of a random access procedure. The operations of 1720 may be performed in accordance with examples as disclosed herein. In some examples, aspects of the operations of 1720 may be performed by a response message component 930 as described with reference to FIG. 9.

At 1725, the method may include refraining from transmitting the random access message when two or more estimated random access paths indicated by the first response message are detected within a threshold duration of the cyclic shift and the cyclic shift offset. The operations of 1725 may be performed in accordance with examples as disclosed herein. In some examples, aspects of the operations of 1725 may be performed by a random access message manager 935 as described with reference to FIG. 9.

At 1730, the method may include receiving, based on refraining from transmitting the random access message, a second response message including second information indicating a second set of resources for transmitting a second random access preamble associated with a second random access procedure. The operations of 1730 may be performed in accordance with examples as disclosed herein. In some examples, aspects of the operations of 1730 may be performed by a response message component 930 as described with reference to FIG. 9.

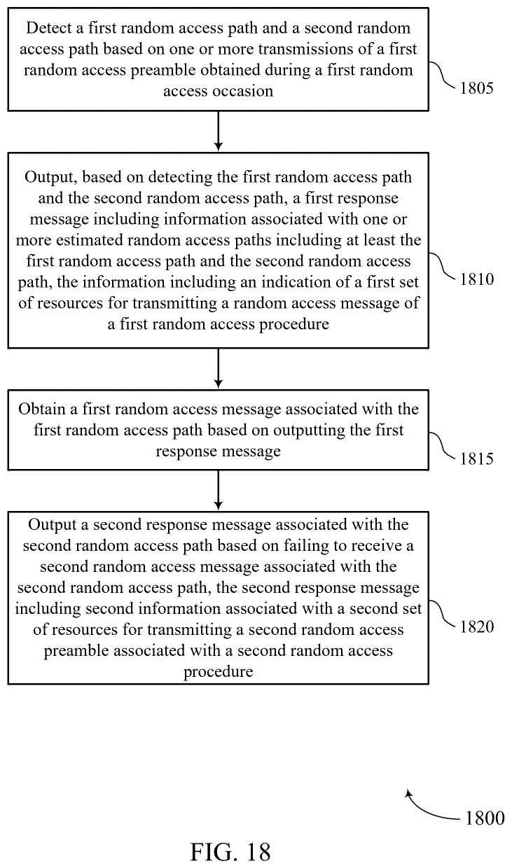

FIG. 18 shows a flowchart illustrating a method 1800 that supports random access message transmission schemes with cyclic shift in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include detecting a first random access path and a second random access path based on one or more transmissions of a first random access preamble obtained during a first random access occasion. The operations of 1805 may be performed in accordance with examples as disclosed herein. In some examples, aspects of the operations of 1805 may be performed by an access path detection manager 1325 as described with reference to FIG. 13.

At 1810, the method may include outputting, based on detecting the first random access path and the second random access path, a first response message including information associated with one or more estimated random access paths including at least the first random access path and the second random access path, the information including an indication of a first set of resources for transmitting a random access message of a first random access procedure. The operations of 1810 may be performed in accordance with examples as disclosed herein. In some examples, aspects of the operations of 1810 may be performed by a response message output component 1330 as described with reference to FIG. 13.

At 1815, the method may include obtaining a first random access message associated with the first random access path based on outputting the first response message. The operations of 1815 may be performed in accordance with examples as disclosed herein. In some examples, aspects of the operations of 1815 may be performed by a random access message component 1335 as described with reference to FIG. 13.

At 1820, the method may include outputting a second response message associated with the second random access path based on failing to receive a second random access message associated with the second random access path, the second response message including second information associated with a second set of resources for transmitting a second random access preamble associated with a second random access procedure. The operations of 1820 may be performed in accordance with examples as disclosed herein. In some examples, aspects of the operations of 1820 may be performed by a response message output component 1330 as described with reference to FIG. 13.

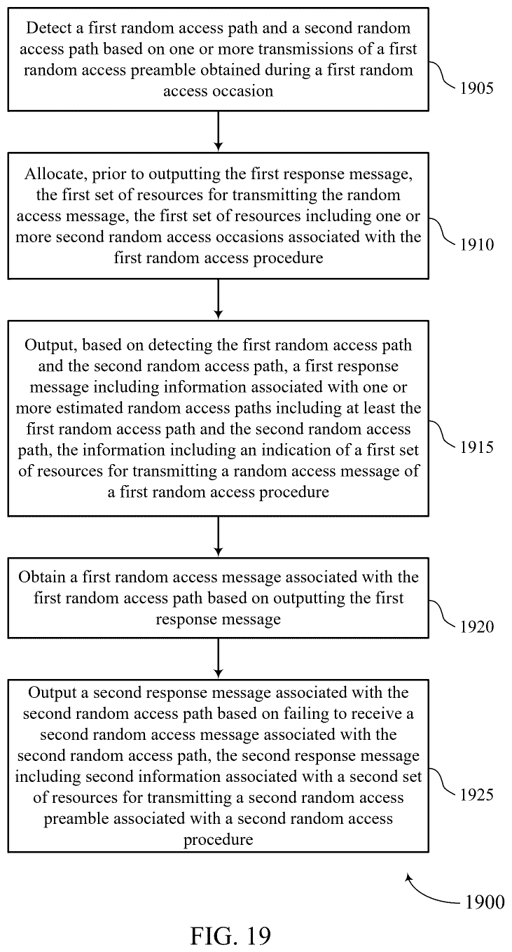

FIG. 19 shows a flowchart illustrating a method 1900 that supports random access message transmission schemes with cyclic shift in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include detecting a first random access path and a second random access path based on one or more transmissions of a first random access preamble obtained during a first random access occasion. The operations of 1905 may be performed in accordance with examples as disclosed herein. In some examples, aspects of the operations of 1905 may be performed by an access path detection manager 1325 as described with reference to FIG. 13.

At 1910, the method may include allocating, prior to outputting the first response message, the first set of resources for transmitting the random access message, the first set of resources including one or more second random access occasions associated with the first random access procedure. The operations of 1910 may be performed in accordance with examples as disclosed herein. In some examples, aspects of the operations of 1910 may be performed by a resource allocation component 1340 as described with reference to FIG. 13.

At 1915, the method may include outputting, based on detecting the first random access path and the second random access path, a first response message including information associated with one or more estimated random access paths including at least the first random access path and the second random access path, the information including an indication of a first set of resources for transmitting a random access message of a first random access procedure. The operations of 1915 may be performed in accordance with examples as disclosed herein. In some examples, aspects of the operations of 1915 may be performed by a response message output component 1330 as described with reference to FIG. 13.

At 1920, the method may include obtaining a first random access message associated with the first random access path based on outputting the first response message. The operations of 1920 may be performed in accordance with examples as disclosed herein. In some examples, aspects of the operations of 1920 may be performed by a random access message component 1335 as described with reference to FIG. 13.

At 1925, the method may include outputting a second response message associated with the second random access path based on failing to receive a second random access message associated with the second random access path, the second response message including second information associated with a second set of resources for transmitting a second random access preamble associated with a second random access procedure. The operations of 1925 may be performed in accordance with examples as disclosed herein. In some examples, aspects of the operations of 1925 may be performed by a response message output component 1330 as described with reference to FIG. 13.

Aspect 1: A method for wireless communications at a UE, comprising: transmitting a random access preamble via a random access occasion in accordance with a cyclic shift of a set of candidate cyclic shifts and with a cyclic shift offset of a set of candidate cyclic shift offsets; receiving, based at least in part on transmitting the random access preamble, a first response message indicating information associated with one or more estimated random access paths corresponding to one or more random access preambles received by a network entity within a duration, the information comprising an indication of a set of resources for transmitting a random access message of a random access procedure; refraining from transmitting the random access message when two or more estimated random access paths indicated by the first response message are detected within a threshold duration of the cyclic shift and the cyclic shift offset; and receiving, based at least in part on refraining from transmitting the random access message, a second response message comprising second information indicating a second set of resources for transmitting a second random access preamble associated with a second random access procedure.

Aspect 2: The method of aspect 1, further comprising: selecting the cyclic shift offset from the set of candidate cyclic shift offsets based at least in part on a pseudo-random function.

Aspect 3: The method of any of aspects 1 through 2, further comprising: receiving, prior to transmitting the random access preamble, an indication of the set of candidate cyclic shift offsets; and selecting the cyclic shift offset from the set of candidate cyclic shift offsets based at least in part on receiving the indication, wherein transmitting the random access preamble is based at least in part on selecting the cyclic shift offset.

Aspect 4: The method of any of aspects 1 through 3, further comprising: transmitting the random access message when a single estimated random access path indicated by the first response message is detected within the threshold duration of the cyclic shift and the cyclic shift offset; receiving a third response message based at least in part on transmitting the random access message; and establishing a connection with a serving cell of the network entity based at least in part on receiving the third response message.

Aspect 5: The method of any of aspects 1 through 4, further comprising: transmitting the second random access preamble in accordance with a second random access occasion indicated by the second set of resources based at least in part on receiving the second response message.

Aspect 6: The method of aspect 5, further comprising: receiving a third response message based at least in part on transmitting the second random access preamble; transmitting a second random access message based at least in part on receiving the third response message; and establishing a connection with a serving cell of the network entity based at least in part on transmitting the second random access message.

Aspect 7: The method of any of aspects 1 through 6, further comprising: receiving, via the first response message, an indication of one or more detected cyclic shifts that are detected by the network entity within the duration, each of the one or more detected cyclic shifts corresponding to a respective estimated random access path of the one or more estimated random access paths.

Aspect 8: The method of aspect 7, further comprising: calculating, when a single estimated random access path is detected within the threshold duration of the cyclic shift and the cyclic shift offset, a timing advance based at least in part on a difference between a detected cyclic shift and the cyclic shift and the cyclic shift offset used for transmitting the random access preamble; and transmitting the random access message based at least in part on calculating the timing advance.

Aspect 9: The method of any of aspects 1 through 8, wherein the information further comprises a transmit power control command for each random access path of the one or more estimated random access paths, and a random access message is transmitted in accordance with the transmit power control command.

Aspect 10: The method of any of aspects 1 through 9, further comprising: comparing each of the one or more estimated random access paths to the threshold duration; and detecting a quantity of the one or more estimated random access paths within the threshold duration of the cyclic shift and the cyclic shift offset based at least in part on the comparing.

Aspect 11: The method of any of aspects 1 through 10, wherein the threshold duration is associated with a round trip time between a serving cell and the UE.

Aspect 12: A method for wireless communications at a network entity, comprising: detecting a first random access path and a second random access path based at least in part on one or more transmissions of a first random access preamble obtained during a first random access occasion; outputting, based at least in part on detecting the first random access path and the second random access path, a first response message comprising information associated with one or more estimated random access paths comprising at least the first random access path and the second random access path, the information comprising an indication of a first set of resources for transmitting a random access message of a first random access procedure; obtaining a first random access message associated with the first random access path based at least in part on outputting the first response message; and outputting a second response message associated with the second random access path based at least in part on failing to receive a second random access message associated with the second random access path, the second response message comprising second information associated with a second set of resources for transmitting a second random access preamble associated with a second random access procedure.

Aspect 13: The method of aspect 12, further comprising: allocating, prior to outputting the first response message, the first set of resources for transmitting the random access message, the first set of resources comprising one or more second random access occasions associated with the first random access procedure.

Aspect 14: The method of any of aspects 12 through 13, further comprising: detecting a third random access path based at least in part on the one or more transmissions of the first random access preamble obtained during the first random access occasion; and obtaining a third random access message associated with the third random access path based at least in part on outputting the first response message, the third random access message corresponds to a third UE.

Aspect 15: The method of any of aspects 12 through 14, further comprising: determining that a collision occurred between the first random access path and the second random access path based at least in part on failing to receive the second random access message, wherein outputting the second response message is based at least in part on determining that the collision occurred.

Aspect 16: The method of any of aspects 12 through 15, further comprising: outputting, prior to detecting the first random access path and the second random access path, an indication of a set of candidate cyclic shift offsets, wherein obtaining the one or more transmissions of the first random access preamble is based at least in part on outputting the indication of the set of candidate cyclic shift offsets.

Aspect 17: The method of any of aspects 12 through 16, further comprising: outputting a third response message based at least in part on obtaining the first random access message; and establishing a connection with a first UE associated with the first random access path based at least in part on outputting the third response message.

Aspect 18: The method of any of aspects 12 through 17, further comprising: obtaining the second random access preamble in accordance with the second set of resources based at least in part on outputting the second response message; and outputting a third response message based at least in part on obtaining the second random access preamble.

Aspect 19: The method of aspect 18, further comprising: obtaining a third random access message based at least in part on outputting the third response message; and establishing a connection with a second UE associated with the second random access path based at least in part on obtaining the third random access message.

Aspect 20: The method of any of aspects 12 through 19, further comprising: outputting, via the first response message, an indication of one or more detected cyclic shifts that are detected by the network entity within the first random access occasion, each of the one or more detected cyclic shifts corresponding to a respective estimated random access path of the one or more estimated random access paths.

Aspect 21: A UE for wireless communications, comprising one or more memories storing processor-executable code, and one or more processors coupled with the one or more memories and individually or collectively operable to execute the code to cause the UE to perform a method of any of aspects 1 through 11.

Aspect 22: A UE for wireless communications, comprising at least one means for performing a method of any of aspects 1 through 11.

Aspect 23: A non-transitory computer-readable medium storing code for wireless communications, the code comprising instructions executable by one or more processors to perform a method of any of aspects 1 through 11.

Aspect 24: A network entity for wireless communications, comprising one or more memories storing processor-executable code, and one or more processors coupled with the one or more memories and individually or collectively operable to execute the code to cause the network entity to perform a method of any of aspects 12 through 20.

Aspect 25: A network entity for wireless communications, comprising at least one means for performing a method of any of aspects 12 through 20.

Aspect 26: A non-transitory computer-readable medium storing code for wireless communications, the code comprising instructions executable by one or more processors to perform a method of any of aspects 12 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a random access preamble via a random access occasion in accordance with a cyclic shift of a set of candidate cyclic shifts and with a cyclic shift offset of a set of candidate cyclic shift offsets;
receive, based at least in part on transmitting the random access preamble, a first response message indicating information associated with one or more estimated random access paths corresponding to one or more random access preambles received by a network entity within a duration, the information comprising an indication of a set of resources for transmitting a random access message of a random access procedure;
refrain from transmitting the random access message when two or more estimated random access paths indicated by the first response message are detected within a threshold duration of the cyclic shift and the cyclic shift offset; and
receive, based at least in part on refraining from transmitting the random access message, a second response message comprising second information indicating a second set of resources for transmitting a second random access preamble associated with a second random access procedure.

2. The UE of claim 1, wherein the one or more processors are individually or collectively further operable to execute the code to cause the UE to:
select the cyclic shift offset from the set of candidate cyclic shift offsets based at least in part on a pseudo-random function.

3. The UE of claim 1, wherein the one or more processors are individually or collectively further operable to execute the code to cause the UE to:
receive, prior to transmitting the random access preamble, an indication of the set of candidate cyclic shift offsets; and
select the cyclic shift offset from the set of candidate cyclic shift offsets based at least in part on receiving the indication, wherein transmitting the random access preamble is based at least in part on selecting the cyclic shift offset.

4. The UE of claim 1, wherein the one or more processors are individually or collectively further operable to execute the code to cause the UE to:
transmit the random access message when a single estimated random access path indicated by the first response message is detected within the threshold duration of the cyclic shift and the cyclic shift offset;
receive a third response message based at least in part on transmitting the random access message; and
establish a connection with a serving cell of the network entity based at least in part on receiving the third response message.

5. The UE of claim 1, wherein the one or more processors are individually or collectively further operable to execute the code to cause the UE to:
transmit the second random access preamble in accordance with a second random access occasion indicated by the second set of resources based at least in part on receiving the second response message.

6. The UE of claim 5, wherein the one or more processors are individually or collectively further operable to execute the code to cause the UE to:
receive a third response message based at least in part on transmitting the second random access preamble;
transmit a second random access message based at least in part on receiving the third response message; and
establish a connection with a serving cell of the network entity based at least in part on transmitting the second random access message.

7. The UE of claim 1, wherein the one or more processors are individually or collectively further operable to execute the code to cause the UE to:
receive, via the first response message, an indication of one or more detected cyclic shifts that are detected by the network entity within the duration, each of the one or more detected cyclic shifts corresponding to a respective estimated random access path of the one or more estimated random access paths.

8. The UE of claim 7, wherein the one or more processors are individually or collectively further operable to execute the code to cause the UE to:
calculate, when a single estimated random access path is detected within the threshold duration of the cyclic shift and the cyclic shift offset, a timing advance based at least in part on a difference between a detected cyclic shift and the cyclic shift and the cyclic shift offset used for transmitting the random access preamble; and
transmit the random access message based at least in part on calculating the timing advance.

9. The UE of claim 1, wherein:
the information further comprises a transmit power control command for each random access path of the one or more estimated random access paths, and
the random access message is transmitted in accordance with the transmit power control command.

10. The UE of claim 1, wherein the one or more processors are individually or collectively further operable to execute the code to cause the UE to:
compare each of the one or more estimated random access paths to the threshold duration; and
detect a quantity of the one or more estimated random access paths within the threshold duration of the cyclic shift and the cyclic shift offset based at least in part on the comparing.

11. The UE of claim 1, wherein the threshold duration is associated with a round trip time (RTT) between a serving cell and the UE.

12. A network entity, comprising:
one or more memories storing processor-executable code; and
one or more processors coupled with the one or more memories and individually or collectively operable to execute the code to cause the network entity to:
detect a first random access path and a second random access path based at least in part on one or more transmissions of a first random access preamble obtained during a first random access occasion;
output, based at least in part on detecting the first random access path and the second random access path, a first response message comprising information associated with one or more estimated random access paths comprising at least the first random access path and the second random access path, the information comprising an indication of a first set of resources for transmitting a random access message of a first random access procedure;
obtain a first random access message associated with the first random access path based at least in part on outputting the first response message; and
output a second response message associated with the second random access path based at least in part on failing to receive a second random access message associated with the second random access path, the second response message comprising second information associated with a second set of resources for transmitting a second random access preamble associated with a second random access procedure.

13. The network entity of claim 12, wherein the one or more processors are individually or collectively further operable to execute the code to cause the network entity to:
allocate, prior to outputting the first response message, the first set of resources for transmitting the random access message, the first set of resources comprising one or more second random access occasions associated with the first random access procedure.

14. The network entity of claim 12, wherein the one or more processors are individually or collectively further operable to execute the code to cause the network entity to:
detect a third random access path based at least in part on the one or more transmissions of the first random access preamble obtained during the first random access occasion; and
obtain a third random access message associated with the third random access path based at least in part on outputting the first response message, the third random access message corresponds to a third user equipment (UE).

15. The network entity of claim 12, wherein the one or more processors are individually or collectively further operable to execute the code to cause the network entity to:
determine that a collision occurred between the first random access path and the second random access path based at least in part on failing to receive the second random access message, wherein outputting the second response message is based at least in part on determining that the collision occurred.

16. The network entity of claim 12, wherein the one or more processors are individually or collectively further operable to execute the code to cause the network entity to:
output, prior to detecting the first random access path and the second random access path, an indication of a set of candidate cyclic shift offsets, wherein obtaining the one or more transmissions of the first random access preamble is based at least in part on outputting the indication of the set of candidate cyclic shift offsets.

17. The network entity of claim 12, wherein the one or more processors are individually or collectively further operable to execute the code to cause the network entity to:
output a third response message based at least in part on obtaining the first random access message; and
establish a connection with a first user equipment (UE) associated with the first random access path based at least in part on outputting the third response message.

18. The network entity of claim 12, wherein the one or more processors are individually or collectively further operable to execute the code to cause the network entity to:
obtain the second random access preamble in accordance with the second set of resources based at least in part on outputting the second response message; and
output a third response message based at least in part on obtaining the second random access preamble.

19. The network entity of claim 18, wherein the one or more processors are individually or collectively further operable to execute the code to cause the network entity to:
obtain a third random access message based at least in part on outputting the third response message; and
establish a connection with a second user equipment (UE) associated with the second random access path based at least in part on obtaining the third random access message.

20. The network entity of claim 12, wherein the one or more processors are individually or collectively further operable to execute the code to cause the network entity to:
output, via the first response message, an indication of one or more detected cyclic shifts that are detected by the network entity within the first random access occasion, each of the one or more detected cyclic shifts corresponding to a respective estimated random access path of the one or more estimated random access paths.

21. A method for wireless communications at a user equipment (UE), comprising:
transmitting a random access preamble via a random access occasion in accordance with a cyclic shift of a set of candidate cyclic shifts and with a cyclic shift offset of a set of candidate cyclic shift offsets;
receiving, based at least in part on transmitting the random access preamble, a first response message indicating information associated with one or more estimated random access paths corresponding to one or more random access preambles received by a network entity within a duration, the information comprising an indication of a set of resources for transmitting a random access message of a random access procedure;
refraining from transmitting the random access message when two or more estimated random access paths indicated by the first response message are detected within a threshold duration of the cyclic shift and the cyclic shift offset; and
receiving, based at least in part on refraining from transmitting the random access message, a second response message comprising second information indicating a second set of resources for transmitting a second random access preamble associated with a second random access procedure.

22. The method of claim 21, further comprising:
selecting the cyclic shift offset from the set of candidate cyclic shift offsets based at least in part on a pseudo-random function.

23. The method of claim 21, further comprising:
receiving, prior to transmitting the random access preamble, an indication of the set of candidate cyclic shift offsets; and
selecting the cyclic shift offset from the set of candidate cyclic shift offsets based at least in part on receiving the indication, wherein transmitting the random access preamble is based at least in part on selecting the cyclic shift offset.

24. The method of claim 21, further comprising:
transmitting the random access message when a single estimated random access path indicated by the first response message is detected within the threshold duration of the cyclic shift and the cyclic shift offset;
receiving a third response message based at least in part on transmitting the random access message; and
establishing a connection with a serving cell of the network entity based at least in part on receiving the third response message.

25. A method for wireless communications at a network entity, comprising:
detecting a first random access path and a second random access path based at least in part on one or more transmissions of a first random access preamble obtained during a first random access occasion;
outputting, based at least in part on detecting the first random access path and the second random access path, a first response message comprising information associated with one or more estimated random access paths comprising at least the first random access path and the second random access path, the information comprising an indication of a first set of resources for transmitting a random access message of a first random access procedure;
obtaining a first random access message associated with the first random access path based at least in part on outputting the first response message; and
outputting a second response message associated with the second random access path based at least in part on failing to receive a second random access message associated with the second random access path, the second response message comprising second information associated with a second set of resources for transmitting a second random access preamble associated with a second random access procedure.

26. The method of claim 25, further comprising:
allocating, prior to outputting the first response message, the first set of resources for transmitting the random access message, the first set of resources comprising one or more second random access occasions associated with the first random access procedure.

27. The method of claim 25, further comprising:
detecting a third random access path based at least in part on the one or more transmissions of the first random access preamble obtained during the first random access occasion; and
obtaining a third random access message associated with the third random access path based at least in part on outputting the first response message, the third random access message corresponds to a third user equipment (UE).

28. The method of claim 25, further comprising:
determining that a collision occurred between the first random access path and the second random access path based at least in part on failing to receive the second random access message, wherein outputting the second response message is based at least in part on determining that the collision occurred.

29. The method of claim 25, further comprising:
outputting, prior to detecting the first random access path and the second random access path, an indication of a set of candidate cyclic shift offsets, wherein obtaining the one or more transmissions of the first random access preamble is based at least in part on outputting the indication of the set of candidate cyclic shift offsets.

30. The method of claim 25, further comprising:
outputting a third response message based at least in part on obtaining the first random access message; and
establishing a connection with a first user equipment (UE) associated with the first random access path based at least in part on outputting the third response message.
